(19) United States
(12) Patent Application Publication
(10) Pub. No.: US 2012/0256965 A1
(43) Pub. Date: Oct. 11, 2012

(54) DISPLAY CONTROL DEVICE, DISPLAY CONTROL METHOD, PROGRAM, AND DISPLAY CONTROL SYSTEM

(75) Inventors: Hideki Iwami, Saitama (JP); Tomoya Yamaura, Tokyo (JP); Osamu Yoshimura, Kanagawa (JP)

(73) Assignee: Sony Corporation, Tokyo (JP)

(21) Appl. No.: 13/435,154

(22) Filed: Mar. 30, 2012

(30) Foreign Application Priority Data
Apr. 7, 2011 (JP) 2011-085177

(51) Int. Cl. G09G 5/00

(52) U.S. Cl. 345/672

(57) ABSTRACT

There is provided a display control device, including a communication section for communicating with an external device, a position specification section for specifying positions of an imaging device, which captures an image, and a display device, which displays the image, a process determination section for determining whether to cause the captured image to be reversed in a horizontal direction on the basis of the positions of the display device and the imaging device and a processing section for selectively reversing the captured image in the horizontal direction, wherein the processing section causes the display device to display the image reversed in the horizontal direction by reversing the captured image in the horizontal direction, if the image is determined to be reversed in the horizontal direction, and causes the display device to display the captured image, if the image is determined not to be reversed in the horizontal direction.

### BACKGROUND

The present disclosure relates to a display control device, a display control method, a program, and a display control system.

At present, an application or service capable of transmitting/receiving content data between devices via a network such as the Internet, a local area network (LAN), or the like is being used.

Technology for extending a range in which content data such as image data, audio data, or the like can be stably transmitted in a network using wireless communication is being developed. An example of technology for extending a range in which content data can be stably transmitted by performing a relay operation is technology disclosed in Japanese Patent Application Laid-Open No. 2005-12710.

### SUMMARY

For example, using the technology disclosed in Japanese Patent Application Laid-Open No. 2005-12710, a communication system capable of stably transmitting content data indicating an image (a moving image or a still image; hereinafter referred to as the same) or an image and an audio (including music; hereinafter referred to as the same) in a wider range can be implemented. Consequently, for example, in the technology disclosed in Japanese Patent Application Laid-Open No. 2005-12710, a user can enjoy an image transmitted in real time (or an image transmitted with a small delay; hereinafter referred to as the same) using a display device such as a portable phone or a personal computer (PC) in an indoor or outdoor site where an event is held.

However, in the above-described case, the user may feel a sense of disharmony between an object the user directly views and an object the user indirectly views via an image transmitted in real time and reflected on a display screen of a display device.

It is desirable to provide a novel and improved display control device, display control method, program, and display control system capable of reducing a sense of disharmony a user may feel.

According to the present disclosure, there is provided a display control device including a communication section for communicating with an external device, a position specification section for specifying positions of an imaging device, which captures an image, and a display device, which displays the image, a process determination section for determining whether to reverse the image captured by the imaging device in a horizontal direction on the basis of the position of the display device, which displays the image, and the position of the imaging device, which captures the image to be displayed, and a processing section for selectively reversing the image captured by the imaging device in the horizontal direction. The processing section may cause the display device to display the image reversed in the horizontal direction, by reversing the image captured by the imaging device in the horizontal direction, if the image is determined to be reversed in the horizontal direction, and may cause the display device to display the image captured by the imaging device, if the image is determined not to be reversed in the horizontal direction.

According to the present disclosure, there is provided a display control method including specifying positions of an imaging device, which captures an image, and a display device, which displays the image, determining whether to cause the image captured by the imaging device to be reversed in a horizontal direction on the basis of the position of the display device, which displays the image, and the position of the imaging device, which captures the image to be displayed, and selectively reversing the image captured by the imaging device in the horizontal direction. The reversing step may include causing the display device to display the image reversed in the horizontal direction, by reversing the image captured by the imaging device in the horizontal direction, if the image is determined to be reversed in the horizontal direction, and causing the display device to display the image captured by the imaging device, if the image is determined not to be reversed in the horizontal direction.

According to the present disclosure, there is provided a program for causing a computer to execute specifying positions of an imaging device, which captures an image, and a display device, which displays the image, determining whether to cause the image captured by the imaging device to be reversed in a horizontal direction on the basis of the position of the display device, which displays the image, and the position of the imaging device, which captures the image to be displayed, and selectively reversing the image captured by the imaging device in the horizontal direction. The reversing step may include causing the display device to display the image reversed in the horizontal direction, by reversing the image captured by the imaging device in the horizontal direction, if the image is determined to be reversed in the horizontal direction, and causing the display device to display the image captured by the imaging device, if the image is determined not to be reversed in the horizontal direction.

According to the present disclosure, there is provided a display control system including an imaging device for capturing one or more images, a display device for displaying the one or more images, a display control device for communicating with the imaging device and the display device. The display control device may include a communication section for communicating with the imaging device and the display device, a position specification section for specifying positions of the imaging device and the display device, a process determination section for determining whether to cause the image captured by the imaging device to be reversed in a horizontal direction on the basis of the position of the display device, which displays the image, and the position of the imaging device, which captures the image to be displayed, and a processing section for selectively reversing the image captured by the imaging device in the horizontal direction. The processing section may cause the image signal indicating the image reversed in the horizontal direction to be transmitted to a display device of a transmission destination of the image signal transmitted from the imaging device, by reversing the image indicated by the image signal transmitted from the imaging device and received by the communication section in the horizontal direction, if the image is determined to be reversed in the horizontal direction, and may cause the image signal transmitted from the imaging device and received by the communication section to be transmitted to the display device of the transmission destination, if the image is determined not to be reversed in the horizontal direction.

According to the present disclosure, it is possible to reduce a sense of disharmony a user may feel.

### BRIEF DESCRIPTION OF THE DRAWINGS

FIG. 1 is an explanatory diagram illustrating a display control method according to this embodiment;

FIG. 2 is an explanatory diagram illustrating a display control method according to this embodiment;

FIG. 3 is an explanatory diagram illustrating a display control method according to this embodiment;

FIG. 4 is an explanatory diagram illustrating a display control method according to this embodiment;

FIG. 5 is an explanatory diagram illustrating an example of a configuration of a display control system according to a first embodiment;

FIG. 6 is a flowchart illustrating an example of a process in a display control device according to this embodiment;

FIG. 7 is an explanatory diagram illustrating an example of a method of selecting an imaging device in a display device according to this embodiment;

FIG. 8 is an explanatory diagram illustrating an example of a reversal determination process in the display control device according to this embodiment;

FIG. 9 is an explanatory diagram illustrating an example of a method of indicating that the display control device reverses an image to a user of the display device according to this embodiment;

FIG. 10 is a flowchart illustrating another example of a process in the display control device according to this embodiment;

FIG. 11 is a block diagram illustrating an example of the configuration of the display control device according to this embodiment;

FIG. 12 is an explanatory diagram illustrating an example of a hardware configuration of the display control device according to this embodiment;

FIG. 13 is an explanatory diagram illustrating an example of a configuration of a display control system according to a second embodiment;

FIG. 14 is a block diagram illustrating an example of a configuration of a display device according to this embodiment;

FIG. 15 is an explanatory diagram illustrating an example of a configuration of a display control system according to a third embodiment; and

FIG. 16 is a block diagram illustrating an example of a configuration of an imaging device according to this embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, description will be given in the following order.

1. Display Control Method According to This Embodiment

2. Display Control System According to This Embodiment

3. Program According to This Embodiment

(Display Control Method According to This Embodiment)

Before the description of a configuration of the display control system according to this embodiment, the display control method according to this embodiment will be described. Hereinafter, the display control systems according to these embodiments such as a display control system 1000 according to a first embodiment, a display control system 2000 according to a second embodiment, and a display control system 3000 according to a third embodiment as will be described later may be collectively referred to as a “display control system” with no reference numeral. In addition, hereinafter, the display control system (more specifically, a device constituting the display control system) is described as performing the display control method according to this embodiment.

In addition, hereinafter, an example in which an imaging device capable of capturing an image captures an image and an image signal indicating the image captured by the imaging device is transmitted to a display device in real time (or with a small delay; hereinafter referred to as the same) by wired communication and/or wireless communication will be described. Here, an example of transmission using a line-based codec is used as a method of transmitting an image in the display control system according to this embodiment. Here, the transmission using the line-based codec may be transmission using an image compression scheme of shortening a delay time by dividing one picture into N-line sets (N is greater than or equal to 1), and encoding an image for each division set (line block). When the line-based codec is used, a scale of a high-speed process or hardware can be reduced, for example, because an amount of information to be handled in one unit of image compression is small, in addition to an advantage of a small delay. Of course, the image transmission scheme according to this embodiment is not limited to a scheme using the above-described line-based codec.

In addition, an example of a signal indicating an image to be encoded using a compression/decompression scheme in which hierarchical coding is possible such as an image of Moving Picture Experts Group (MPEG)-4 (International Organization for Standardization (ISO)/International Electrotechnical Commission (IEC) 14496) or an image of Joint Photographic Experts Group (JPEG) 2000 is included as an image signal according to this embodiment. The image signal according to this embodiment is not limited to the signal indicating the image to be encoded using the compression/decompression scheme in which the hierarchical coding is possible.

In addition, an Internet protocol (IP)-based communication protocol such as a user datagram protocol (UDP) is included as an example of a communication protocol in the display control system according to this embodiment. The communication protocol in the display control system according to this embodiment is not limited to the above, and any communication protocol may be used in the display control system.

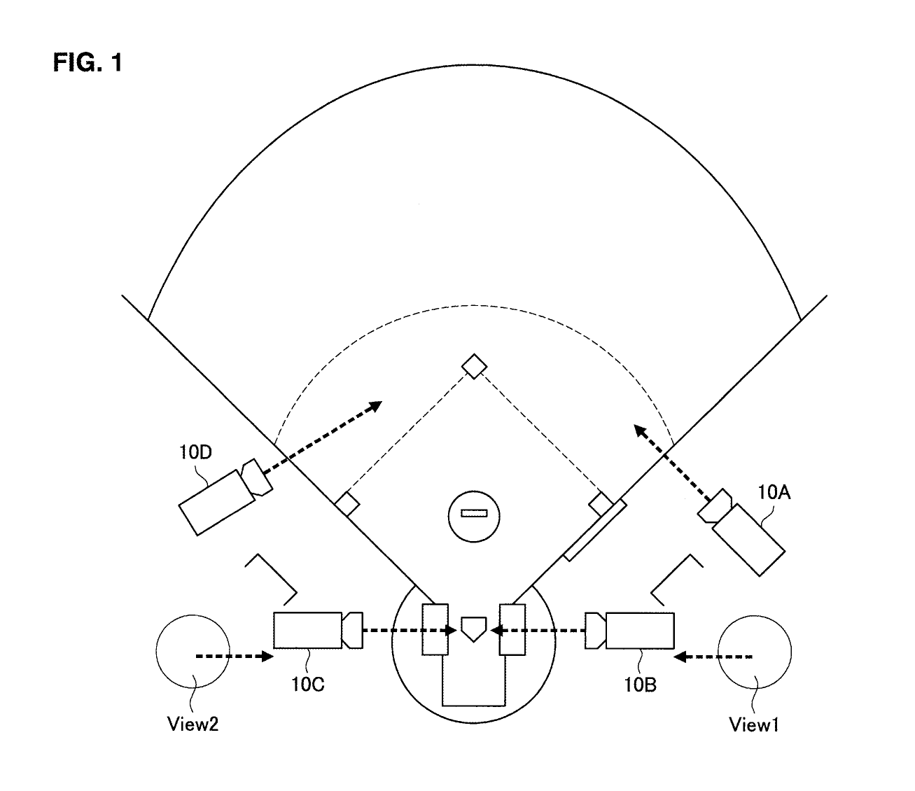

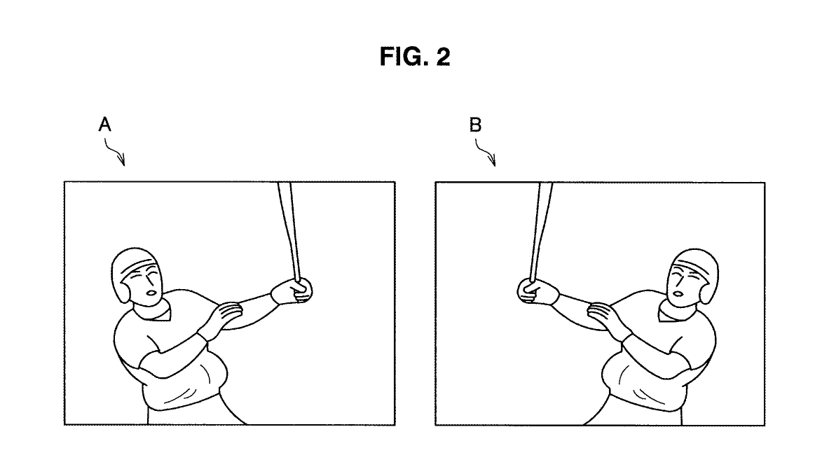

FIGS. 1 and 2 are explanatory diagrams illustrating the display control method according to this embodiment. FIG. 1 illustrates an example in which four imaging devices (imaging devices 10A to 10D) that capture images of a baseball field in a ballpark are installed and each imaging device captures an image of an object in an arrow direction and transmits the captured image to a display device. In addition, Views 1 and 2 are illustrated in FIG. 1 as examples of positions of the user who can view images captured by the imaging devices using the display device. A illustrated in FIG. 2 illustrates an example of an image displayed on a display screen of the display device in View 1 illustrated in FIG. 1, and B illustrated in FIG. 2 illustrates an example of an image displayed on a display screen of the display device in View 2 illustrated in FIG. 1.

For example, when the display device is present in the position of View 1 and the image displayed on the display screen of the display device is captured by the image device 10C, the object the user directly views is substantially consistent with an object displayed on the display screen (that is, the object the user indirectly views via the display screen). That is, in the above-described case, horizontal axes are consistent without being reversed in the object the user directly views and the object the user indirectly views via the image reflected on the display screen of the display device. Consequently, in the above-described case, the user is not likely to feel the sense of disharmony between the object the user directly views and the object the user indirectly views via the image transmitted in real time and reflected on the display screen of the display device.

However, for example, when the display device is present in the position of View 1 and the image displayed on the display screen of the display device is captured by the image device 10B, the object the user directly views may not be consistent with the object displayed on the display screen. That is, in the above-described case, the horizontal axes may be reversed in the object the user directly views and the object the user indirectly views via the image reflected on the display screen of the display device. Here, when the horizontal axis in the object the user directly views and the horizontal axis in the object the user indirectly views via the image reflected on the display screen of the display device are reversed, the reversal of the horizontal axis is likely to be recognized by the user as the sense of disharmony. Consequently, in the above-described case, the user may feel the sense of disharmony between when the user directly views the object and when the user indirectly views the object via the image transmitted in real time and reflected on the display screen of the display device.

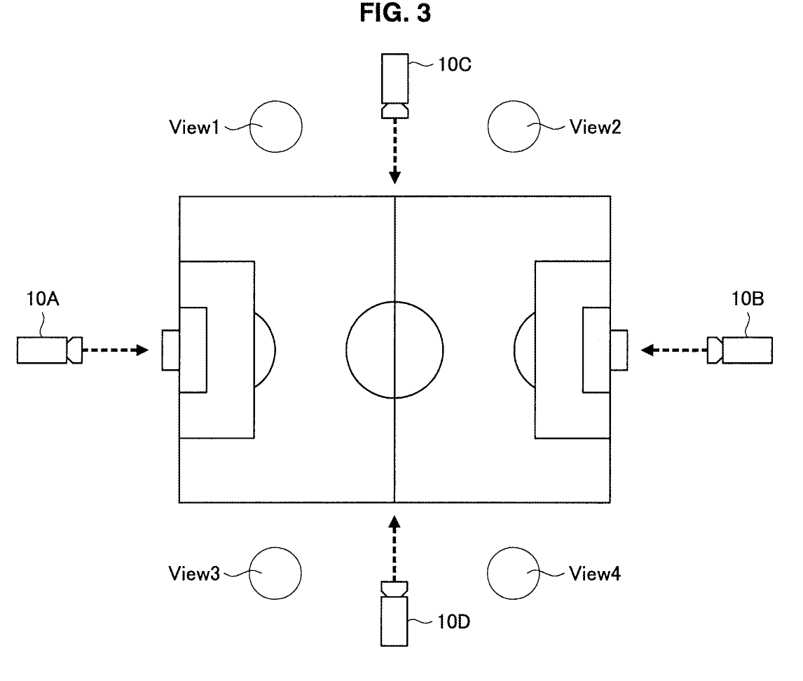

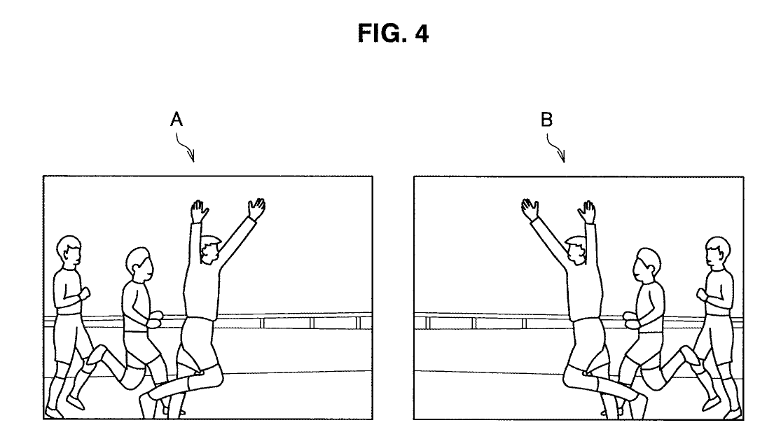

A situation in which the user feels the sense of disharmony is not limited to when the ballpark field as illustrated in FIG. 1 is imaged by the imaging device. FIGS. 3 and 4 are explanatory diagrams illustrating a display control method according to this embodiment. FIG. 3 illustrates an example in which four imaging devices (imaging devices 10A to 10D) that capture images of a soccer field are installed in a soccer ground and each imaging device captures an image of an object in an arrow direction and transmits the captured image to a display device. In addition, Views 1 to 4 are illustrated in FIG. 3 as an example of positions of the user who can view images captured by the imaging devices using the display device. A illustrated in FIG. 4 illustrates an example of an image displayed on a display screen of the display device in View 1 illustrated in FIG. 3, and B illustrated in FIG. 4 illustrates an example of an image displayed on a display screen of the display device in View 3 illustrated in FIG. 3.

For example, when the display device is in a position of View 1 or 2 and an image displayed on the display screen of the display device is an image of an object at the center of the field captured by the imaging device 10C, the object the user directly views is substantially consistent with the object displayed on the display screen (that is, the object the user indirectly views via the display screen). In the above-described case, the horizontal axes are consistent without being reversed in the object the user directly views and the object the user indirectly views via the image reflected on the display screen of the display device. Consequently, in the above-described case, the user is not likely to feel the sense of disharmony between the object the user directly views and the object the user indirectly views via the image transmitted in real time and reflected on the display screen of the display device.

In addition, for example, when the display device is in a position of View 1 or 2 and an image displayed on the display screen of the display device is an image of an object at the center of the field captured by the imaging device 10D, the horizontal axes may be reversed in the object the user directly views and the object the user indirectly views via the image reflected on the display screen of the display device as in the case of FIG. 1. Consequently, in the above-described case, the user may feel the sense of disharmony between when the user directly views the object and when the user indirectly views the object via the image transmitted in real time and reflected on the display screen of the display device.

In addition, for example, when the display device is in the position of View 1 or 2 and the user switches the imaging device for capturing the image to be displayed on the display screen from the imaging device 10C to the imaging device 10A or 10B, positional relationships between the position of the display device, the object to be imaged, and the imaging device are varied. Thus, according to the above-described positional relationships after switching, the horizontal axes are likely to be reversed in the object the user directly views and the object the user indirectly views via the image reflected on the display screen of the display device. Consequently, according to the above-described positional relationships after switching, the user may feel the sense of disharmony between when the user directly views the object and when the user indirectly views the object via the image transmitted in real time and reflected on the display screen of the display device.

As described above, when the imaging device captures an image and an image signal indicating the image captured by the imaging device is transmitted to the display device in real time by wired communication and/or wireless communication, the user may feel the sense of disharmony between the object the user directly views and the object the user indirectly views via the image transmitted in real time and reflected on the display screen of the display device.

In the display control system according to this embodiment, a display control device (which may hereinafter be referred to as “display control device 100”) constituting the display control system selectively reverses the image captured by the imaging device in a horizontal direction on the basis of the position of the display device on which the image is displayed and the position of the imaging device that captures the image to be displayed on the display device. The display control device 100 causes the display device to display the reversed image when reversing the image in the horizontal direction, and causes the display device to display the image captured by the imaging device when not reversing the image in the horizontal direction.

Here, a process of reversing the image in the horizontal direction according to this embodiment corresponds to a process of generating a mirror image from the image. Using any method capable of generating the mirror image from the image, the display control device 100 reverses the image in the horizontal direction. Hereinafter, an operation of reversing the image in the horizontal direction may be referred to as “minor image reversal.”

In the display control system, the display control device 100 selectively reverses the image captured by the imaging device on the basis of the position of the display device and the position of the imaging device, and causes the display device to display either the reversed image or the image captured by the imaging device. More specifically, in the display control system, the display control device 100 selectively reverses the image captured by the imaging device in the horizontal direction, thereby causing the horizontal axis in the object the user directly views to be consistent with the horizontal axis in the object the user indirectly views via the image reflected on the display screen of the display device. Therefore, the display control system can reduce the sense of disharmony the user may feel.

Hereinafter, an example of a configuration of the display control system according to this embodiment will be described and also a specific example of a process related to the display control method according to this embodiment will be described.

(Display Control System According to This Embodiment)

(1) Display Control System According to First Embodiment

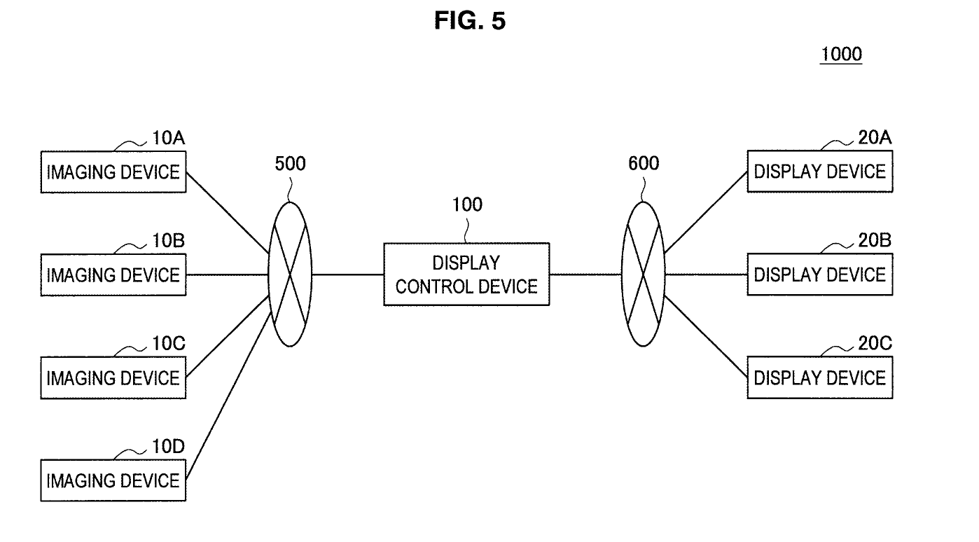

FIG. 5 is an explanatory diagram illustrating an example of the configuration of the display control system 1000 according to the first embodiment. The display control system 1000 has a display control device 100, imaging devices 10A to 10D, and display devices 20A to 20C. In addition, the display control device 100 and the imaging devices 10A to 10D are connected by a network 500. In addition, the display control device 100 and the display devices 20A to 20C are connected by a network 600.

Here, for example, the connection according to this embodiment may mean that it is in a communicable state (or it causes the communicable state). In addition, a wired network such as a local area network (LAN) or a wide area network (WAN), a wireless network such as a wireless LAN (WLAN), a wireless WAN (WWAN) via a base station or a wireless metropolitan area network (MAN) (WMAN), or the Internet using a communication protocol such as transmission control protocol/Internet protocol (TCP/IP) is included as an example of the networks 500 and 600. The networks 500 and 600 may be the same type of networks or different types of networks.

Although the configuration in which the display control system 1000 has the four imaging devices 10A to 10D is illustrated in FIG. 5, the configuration of the display control system 1000 according to the first embodiment is not limited to the above. For example, the display control system 1000 according to the first embodiment may have one or more imaging devices (which may hereinafter be collectively referred to as an “imaging device 10”). In addition, although the configuration in which the display control system 1000 has the three display devices 20A to 20C is illustrated in FIG. 5, the configuration of the display control system 1000 according to the first embodiment is not limited to the above. For example, the display control system 1000 according to the first embodiment may have one or more display devices (which may hereinafter be collectively referred to as a “display device 20”).

[Display Control Device 100]

The display control device 100 relays communication between the imaging device 10 and the display device 20, and controls the display device 20 to display an image captured by the imaging device 10.

More specifically, the display control device 100 selectively reverses an image indicating an image signal transmitted from the imaging device 10 in the horizontal direction on the basis of a position of the display device 20, which displays the image, and a position of the imaging device 10, which captures the image to be displayed on the display device 20. When reversing the image in the horizontal direction, the display control device 100 transmits an image signal indicating the reversed image to the display device 20 of a transmission destination of the image signal transmitted from the imaging device 10. In addition, when not reversing the image in the horizontal direction, the display control device 100 transmits the image signal transmitted from the imaging device 10 to the display device 20 of the transmission destination.

Here, the display control device 100 specifies the display device 20 of the transmission destination of packet data, for example, by referring to path control information regarding control of a communication path included in a header of the packet data transmitted from the imaging device 10. For example, when the above-described packet data is an IP packet based on the IP protocol, the display control device 100 specifies the display device 20 of the transmission destination by referring to a destination IP address included in the header (an IP address of the transmission destination). Of course, a method of specifying the display device 20 of the transmission destination in the display control device 100 is not limited to the above.

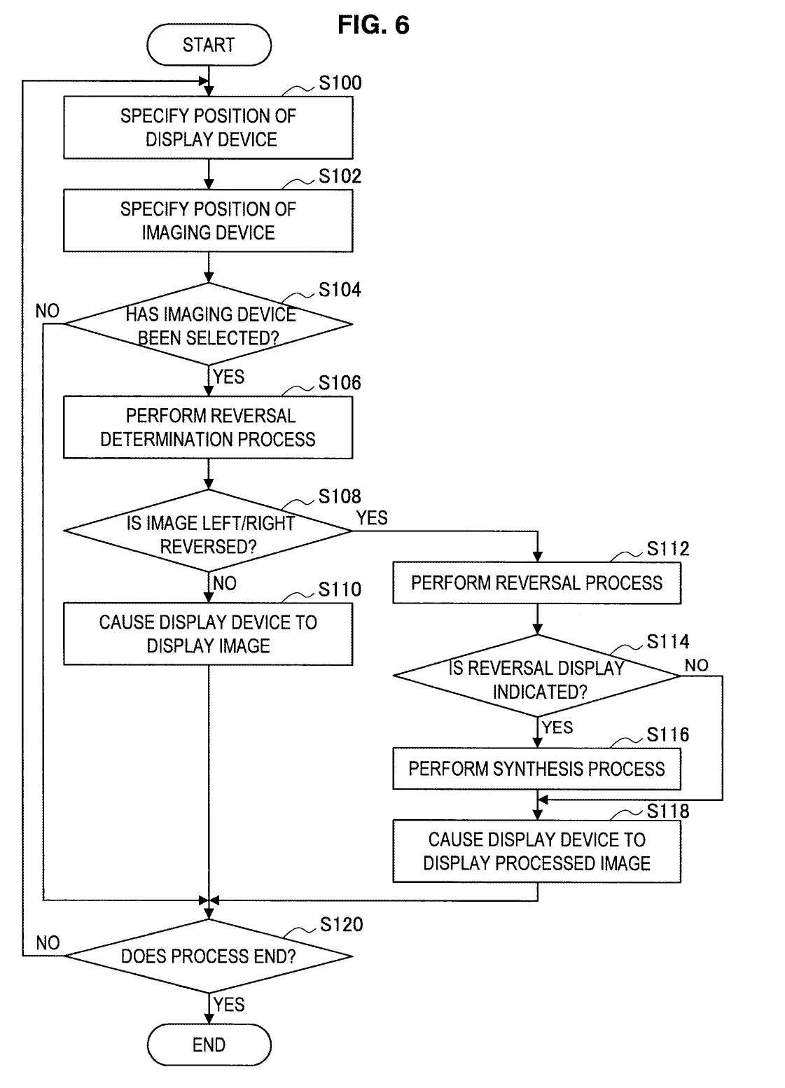

FIG. 6 is a flowchart illustrating an example of a process in the display control device 100 according to this embodiment.

The display control device 100 specifies the position of the display device 20 (S100). The display control device 100 specifies the position of the display device 20, for example, on the basis of position information indicating a device position transmitted from the display device 20. Here, an IP address, coordinate data indicating latitude and longitude, a service set identifier (SSID), a phone number, and the like are included as examples of the position information according to this embodiment.

Although the display control device 100 acquires position information corresponding to the display device 20, for example, by transmitting a position information transmission request for causing the position information to be transmitted to the display device 20, a method of acquiring the position information corresponding to the display device 20 is not limited to the above. For example, the display control device 100 may acquire the position information corresponding to the display device 20 by transmitting the position information periodically/aperiodically transmitted from the display device 20.

In addition, for example, when the position information acquired from the display device 20 is coordinate data, the display control device 100 specifies coordinates indicated by the coordinate data as the position of the display device 20. A method of specifying the position according to this embodiment is not limited to the use of coordinates indicated by coordinate data.

For example, when the position information acquired from the display device 20 indicates an IP address, the display control device 100 specifies a position corresponding to an IP address indicated by the position information using a database (DB) in which IP addresses are associated with positions. Here, although the display control device 100 specifies the position corresponding to the IP address indicated by the position information, for example, by referring to the DB stored in a storage section (to be described later) or the like provided in the display control device 100, a method of specifying the position using the DB is not limited to the above. For example, the display control device 100 may specify the position corresponding to the IP address indicated by the position information by transmitting the IP address indicated by the position information to an external device such as a server storing the DB and acquiring the position corresponding to the IP address from the external device.

In addition, for example, when the display control device 100 and the display device 20 perform communication according to the wireless LAN, the display control device 100 specifies a position corresponding to an SSID or the like indicated by the position information using a DB in which SSIDs and the like are associated with positions if the position information acquired from the display device 20 indicates an SSID, a media access control (MAC) address, or the like. Here, like the above-described DB in which the IP addresses are associated with the positions, the DB in which the SSIDs and the like are associated with the positions may be stored in a storage section (to be described later) provided in the display control device 100 or may be stored in an external device such as a server.

In step S100, the display control device 100 specifies the position of the display device 20, for example, by performing the process as described above using the position information acquired from the display device 20. The process of step S100 in the display control device 100 according to this embodiment is not limited to the above. For example, the display control device 100 can specify the position of the display device 20 using the position information pre-stored in a storage section (not illustrated) or the like.

The display control device 100 specifies the position of the imaging device 10 (S102). Here, the display control device 100 specifies the position of the imaging device 10, for example, using the position information acquired from the imaging device 10, as in step S100. The process of step S102 in the display control device 100 according to this embodiment is not limited to the above. For example, the display control device 100 can specify the position of the imaging device 10, for example, using the position information pre-stored in the storage section (not illustrated) or the like.

Although an example in which the display control device 100 performs the process of step S102 after the process of step S100 is illustrated in FIG. 6, the process of the display control device 100 is not limited to the above. For example, because the process of step S100 and the process of step S102 can be independently performed, the display control device 100 may perform the process of step S100 after the process of step S102, and synchronize the process of step S100 and the process of step S102.

If the process of steps S100 and S102 is performed, the display control device 100 determines whether or not the imaging device 10, which captures an image to be displayed on the display screen in the display device 20, has been selected (S104). The display control device 100 determines that the imaging device 10 has been selected, for example, if a selection signal indicating a specific imaging device 10 transmitted from the display device 20 has been received.

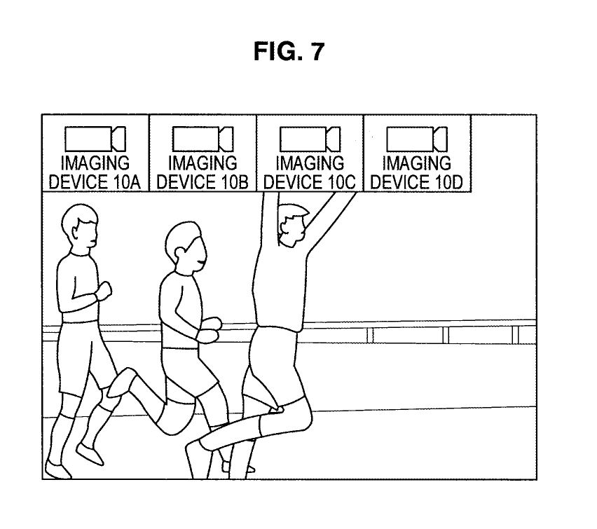

FIG. 7 is an explanatory diagram illustrating an example of a method of selecting the imaging device 10 in the display device 20 according to this embodiment. Here, FIG. 7 illustrates an example of an image displayed on the display screen of the display device 20.

The user of the display device 20 selects one imaging device 10 illustrated in FIG. 7, for example, using an operation device such as a button provided in the display device 20 or an external operation device such as a remote controller. The display device 20 transmits the above-described selection signal to the display control device 100 on the basis of the user's selection operation of selecting the imaging device 10. Of course, an image to be displayed on the display screen of the display device 20 for allowing the user to select the imaging device 10 is not limited to the image illustrated in FIG. 7.

The example of the process in the display control device 100 will be described with reference back to FIG. 6. If no imaging device 10 is determined to have been selected in step S104, the display control device 100 performs the process of step S120 to be described later.

In addition, if the imaging device 10 is determined to have been selected in step S104, the display control device 100 performs a reversal determination process related to whether to reverse the image indicated by the image signal transmitted from the selected imaging device 10 in the horizontal direction (S106).

The display control device 100 determines whether to reverse the image in the horizontal direction on the basis of the position of the display device 20 specified in step S100 and the position of the imaging device 10 specified in step S102.

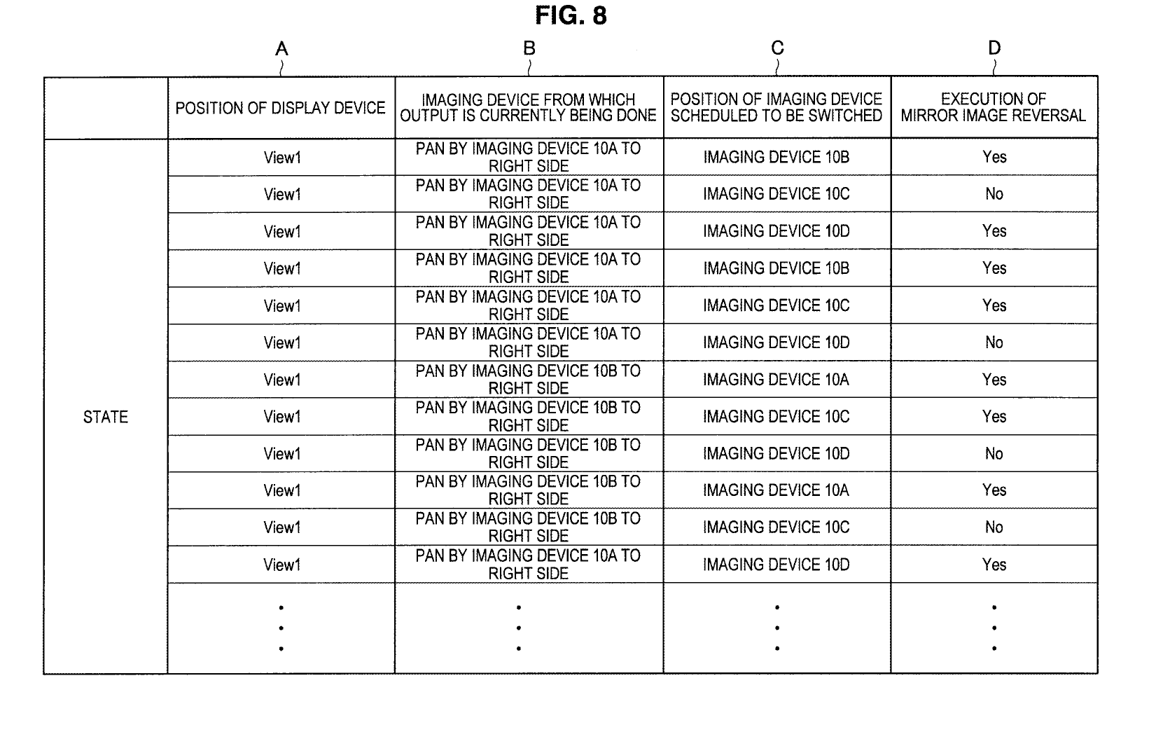

FIG. 8 is an explanatory diagram illustrating an example of the reversal determination process in the display control device 100 according to this embodiment. Here, FIG. 8 illustrates an example of determination conditions for determining whether or not to perform the reversal according to a position (A illustrated in FIG. 8) of a display device 20, information (B illustrated in FIG. 8) indicating the imaging device 10 of a transmission source of an image currently displayed on the display screen of the display device 20, and information (C illustrated in FIG. 8) regarding a selected imaging device 10. In addition, FIG. 8 illustrates an example of determination conditions when four imaging devices (imaging devices 10A to 10D) are installed to image a soccer field in a soccer ground, for example, illustrated in FIG. 3.

Here, the display control device 100 uses, for example, the position of the display device 20 specified in step S100 as a condition illustrated in A of FIG. 8. In addition, the display control device 100 uses, for example, a result of image processing or an imaging state indicated by camera-platform control information indicating a control state of a camera platform transmitted from the imaging device 10 as a condition illustrated in B of FIG. 8. In addition, the display control device 100 uses, for example, the position of the imaging device 10 specified in step S102 as a condition illustrated in C of FIG. 8.

For example, using the determination conditions illustrated in FIG. 8, the display control device 100 determines whether or not to reverse the image in the horizontal direction. The determination conditions according to this embodiment are not limited to those illustrated in FIG. 8. For example, the display control device 100 can determine whether or not to perform the reversal according to A and C illustrated in FIG. 8.

The example of the process in the display control device 100 will be described with reference back to FIG. 6. If the process of step S106 is performed, the display control device 100 determines whether or not to reverse the image in the horizontal direction on the basis of the determination result of step S106 (whether or not to left/right reverse the image) (S108).

If the image is determined not to be reversed in the horizontal direction in step S108, the display control device 100 transmits an image signal transmitted from the selected imaging device 10 to the display device 20 selecting the imaging device 10 (corresponding to the display device 20 of the transmission destination), and causes the display device 20 to display the image (S110). The display control device 100 performs the process of step S120 to be described later. Although not illustrated in FIG. 6, the display control device 100 continues the process of step S110 until there is a display stop request from the display device 20 or until the image is determined to be reversed in the horizontal direction in the process of step S108 that has been re-performed.

In addition, if the image is determined to be reversed in the horizontal direction in step S108, the display control device 100 performs a reversal process of reversing the image indicated by the image signal transmitted from the selected imaging device 10 in the horizontal direction (S112).

If the reversal process is performed in step S112, the display control device 100 determines whether or not to indicate that the image is reversed to the user of the display device 200 (S114). Here, the display control device 100 performs the process of step S114, for example, on the basis of display setting information, which indicates whether or not to indicate the reversal if the image is reversed, transmitted from the display device 20. Although the display control device 100 acquires the above-described display setting information from the display device 20, for example, by transmitting a display setting information transmission request for requesting the transmission of display setting information to the display device 20 when the display control device 100 initiates the process of step S112, a method of acquiring the display setting information is not limited to the above. For example, the display control device 100 may store the display setting information transmitted from the display device 20 in a storage section (not illustrated) or the like on the basis of an operation of the user of the display device 20, regardless of the above-described display setting information transmission request, and may perform the process of step S114 using the display setting information stored in the storage section (not illustrated) or the like.

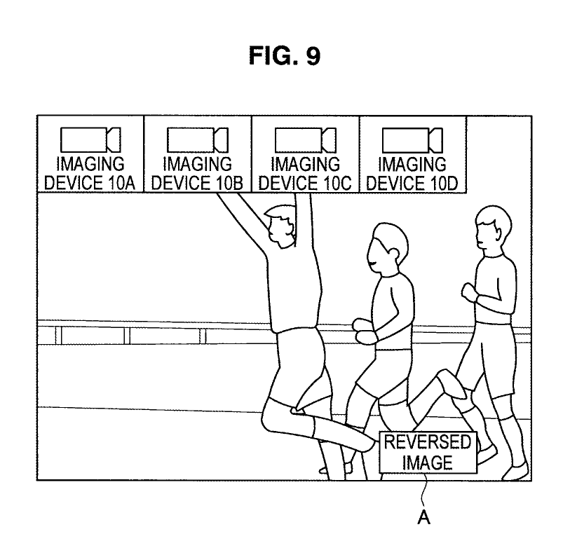

FIG. 9 is an explanatory diagram illustrating an example of a method of indicating that the display control device 100 reverses the image to the user of the display device 20 according to this embodiment. Here, FIG. 9 illustrates an example of an image displayed on the display screen of the display device 20.

As illustrated in A of FIG. 9, the display control device 100 indicates that the image is reversed to the user, for example, by synthesizing the image reversed in the horizontal direction in the process of step S112 with comments indicating a reversed image.

A method of indicating that the image is reversed to the user of the display device 20 according to this embodiment is not limited to a method of synthesizing the comments indicating the reversed image as illustrated in FIG. 9. In addition, the display control device 100 can provide, for example, an audible notification indicating that the image is reversed by audio or the like as well as a visual notification indicating that the image is reversed to the user of the display device 20, for example, as illustrated in FIG. 9. Hereinafter, an example in which the display control device 100 according to this embodiment synthesizes the comments indicating the reversed image with the image reversed in the horizontal direction as illustrated in FIG. 9 will be described.

An example of the process in the display control device 100 will be described with reference back to FIG. 6. If the fact that the image is reversed is determined not to be indicated to the user of the display device 20 in step S114, the display control device 100 performs the process of step S118 to be described later.

In addition, if the fact that the image is reversed is determined to be indicated to the user of the display device 20 in step S114, the display control device 100 synthesizes the comments indicating the reversed image with the image reversed in the horizontal direction in step S112 (S116).

If the fact that the image is reversed is determined not to be indicated to the user of the display device 20 in step S114, or if the process of step S116 is performed, the display control device 100 transmits an image signal indicating the reversed image to the display device 20 selecting the imaging device 10 (corresponding to the display device 20 of the transmission destination) and causes the display device 20 to display the image (S118). Although not illustrated in FIG. 6, the display control device 100 continues the process of step S118, for example, until there is a display stop request from the display device 20 or until the image is determined not to be reversed in the horizontal direction in the process of step S108 that has been re-performed.

If the imaging device 10 is determined not to have been selected in step S104, or if the process of step S110 or the process of step S118 is performed, the display control device 100 determines whether or not to end a display control-related process (S120). Here, the display control device 100 determines to end the display control-related process, for example, if a predetermined operation signal indicating a process end delivered from an operation section (to be described later) or a predetermined external operation signal indicating a process end transmitted from an external operation device such as a remote controller has been detected.

If the display control-related process is determined to be ended in step S120, the display control device 100 ends the display control-related process. In addition, if the display control-related process is determined not to be ended in step S120, the display control device 100 iterates the process from step S100.

The display control device 100 controls a display in the display device 20, for example, by performing the process illustrated in FIG. 6.

For example, as illustrated in FIG. 6, the display control device 100 can cause the horizontal axis in the object the user directly views to be consistent with the horizontal axis in the object the user indirectly views via the image reflected on the display screen of the display device by performing (A) a process of specifying positions of the imaging device and the display device (for example, corresponding to steps S100 and S102 of FIG. 6), (B) a process of determining whether to reverse the image in the horizontal direction (for example, corresponding to a process of steps S104 to S108 of FIG. 6), and (C) a process of selectively reversing the image in the horizontal direction and causing the display device to display the selectively reversed image (for example, corresponding to steps S110 to S118 of FIG. 6). Consequently, the display control device 100 performs the above-described processes (A) to (C), thereby implementing the display control method according to this embodiment described above in the display control system 1000.

Therefore, the display control device 100 can reduce a sense of disharmony the user may feel, for example, by performing the process illustrated in FIG. 6.

The process in the display control device 100 according to this embodiment is not limited to the process illustrated in FIG. 6. For example, if there is an audio corresponding to an image captured by the imaging device 10 (for example, an audio collected by a sound collection device provided in the imaging device 10 or a sound collection device connected to the imaging device 10), the display control device 100 can selectively left/right reverse a channel of an audio signal indicating the audio in synchronization with the image reversal. Next, a process of selectively left/right reversing the channel of the audio signal indicating the audio will be described as another example of the process in the display control device 100 according to this embodiment.

Here, although an audio signal indicating a stereo audio having two channels is included as an example of an audio signal of an object to be processed according to this embodiment, the audio signal of the object to be processed according to this embodiment is not limited to the above. For example, the audio signal according to this embodiment may be an audio signal having three or more channels. If the audio signal of the three or more channels serves as the object to be processed as described above, the display control device 100 selectively reverses, for example, an audio signal of a channel corresponding to the left and an audio signal of a channel corresponding to the right. If the number of sets of channels corresponding to left and right viewpoints is two or more, the display control device 100 may designate these sets as the object to be selectively reversed. Further, if the audio signal is not a channel set as in an audio signal from an odd-numbered channel, the display control device 100, for example, directly outputs an audio signal of a channel, which is not the channel set, without designating an object to be reversed.

Hereinafter, an audio signal of one channel serving as an object to be selectively reversed among audio signals of a plurality of channels is referred to as a “first-channel audio signal.” An audio signal of another channel serving as an object to be selectively reversed which forms a set with the audio signal of the one channel is referred to as a “second-channel audio signal.”

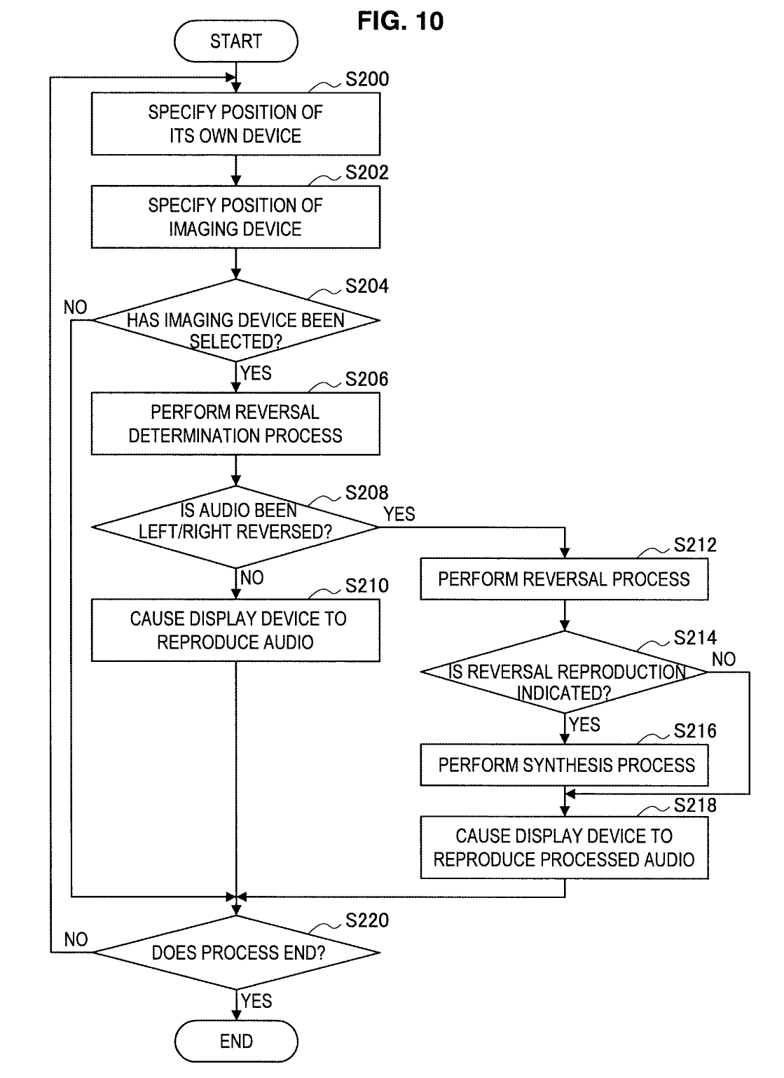

FIG. 10 is a flowchart illustrating another example of the process of the display control device 100 according to this embodiment.

The display control device 100 specifies the position of the display device 20 as in step S100 illustrated in FIG. 6 (S200). The display control device 100 may specify the position of the display device 20 using a result of the process of step S100 illustrated in FIG. 6.

In addition, the display control device 100 specifies the position of the imaging device 10 as in step S102 illustrated in FIG. 6 (S202). The display control device 100 may specify the position of the imaging device 10 using a result of the process of step S102 illustrated in FIG. 6.

Although an example in which the display control device 100 performs the process of step S202 after the process of step S200 is illustrated in FIG. 10, the process in the display control device 100 is not limited to the above. For example, the display control device 100 may perform the process of step S200 after the process of step S202 as in the process illustrated in FIG. 6, and synchronize and perform the process of step S200 and the process of step S202.

If the process of steps S200 and S202 is performed, the display control device 100 determines whether or not the imaging device 10, which acquires the image displayed on the display screen in the display device 20, has been selected as in step S104 illustrated in FIG. 6 (S204). The display control device 100 may determine whether or not the imaging device 10 has been selected using a result of the process of step S104 illustrated in FIG. 6.

If no imaging device 10 is determined to have been selected in step S204, the display control device 100 performs the process of step S220 to be described later.

In addition, if the imaging device 10 is determined to have been selected in step S204, the display control device 100 performs a reversal determination process related to whether or not to left/right reverse a channel of an audio signal corresponding to an image signal transmitted from the selected imaging device 10 (S206). Here, the display control device 100 performs the process of step S206, for example, by performing the same process in step S106 illustrated in FIG. 6. The display control device 100 may not perform the process of step S206 if a determination result in step S106 illustrated in FIG. 6 is used. If the process of step S206 is not performed, the display control device 100 performs the process of step S208 to be described later using the determination result in step S106 illustrated in FIG. 6.

If the process of step S206 is performed, the display control device 100 determines whether or not to left/right reverse the channel of the audio signal corresponding to the image signal (whether or not to left/right reverse the audio) on the basis of the determination result in step S206 (or the determination result in the step S106 illustrated in FIG. 6) (S208).

If the channel of the audio signal is determined not to be left/right reversed in step S208, the display control device 100 transmits the audio signal corresponding to the image signal transmitted from the selected imaging device 10 to the display device 20 selecting the imaging device 10 (corresponding to the display device 20 of the transmission destination), and causes the display device 20 to reproduce the audio (S210). The display control device 100 performs the process of step S220 to be described later. Although not illustrated in FIG. 10, the display control device 100 continues the process of step S210, for example, until there is a display stop request from the display device 20 or until the audio is determined to be left/right reversed in the process of step S208 that has been re-performed.

If the channel of the audio signal is determined not to be left/right reversed in step S208, the display control device 100 performs a reversal process of reversing a first-channel audio signal and a second-channel audio signal among audio signals corresponding to the image signal transmitted from the selected imaging device 10 (S212).

If the reversal process is performed in step S212, the display control device 100 determines whether or not to indicate that the audio is left/right reversed to the user of the display device 20, for example, as in step S114 illustrated in FIG. 6 (S214). The display control device 100 may determine whether or not to indicate that the audio is left/right reversed to the user of the display device 20 using a result of the process of step S114 illustrated in FIG. 6. In addition, although the display control device 100 indicates that the audio is left/right reversed to the user by synthesizing comments indicating that the audio is left/right reversed, for example, as in the example illustrated in FIG. 9, a method of notifying the user of the fact that the audio is left/right reversed is not limited to the above.

If the fact that the audio is left/right reversed is determined not to be indicated to the user of the display device 20 in step S214, the display control device 100 performs the process of step S218 to be described later.

In addition, if the fact that the audio is left/right reversed is determined to be indicated to the user of the display device 20 in step S214, the display control device 100 synthesizes the comments indicating that the audio is left/right reversed with the image reversed in the horizontal direction in step S112 illustrated in FIG. 6 (S216).

If the fact that the audio is left/right reversed is determined not to be indicated to the user of the display device 20 in step S214, or if the process of step S216 is performed, the display control device 100 transmits audio signals obtained by reversing the first-channel audio signal and the second-channel audio signal in step S212 to the display device 20 selecting the imaging device 10 (corresponding to the display device 20 of the transmission destination) and causes the display device 20 to reproduce the audio (S218). Although not illustrated in FIG. 10, the display control device 100 continues the process of step S218, for example, until there is a display stop request from the display device 20 or until the audio is determined to be left/right reversed in the process of step S208 that has been re-performed.

If the imaging device 10 is determined not to have been selected in step S204, or if the process of step S210 or the process of step S218 is performed, the display control device 100 determines whether or not to end a display control-related process as in step S120 illustrated in FIG. 6 (S220).

If the display control-related process is determined to be ended in step S220, the display control device 100 ends the display control-related process. In addition, if the display control-related process is determined not to be ended in step S220, the display control device 100 iterates the process from step S200.

The display control device 100 can control audio reproduction in the display device 20, for example, by performing the process illustrated in FIG. 10, and selectively left/right reverse a channel of an audio signal in synchronization with the reversal of the image implemented by the process illustrated in FIG. 6. Here, inconsistency in the horizontal axis direction does not occur between the image reversed in the horizontal direction and the audio corresponding to the image by selectively left/right reversing the channel of the audio signal in correspondence with the reversal of the image. Therefore, the display control device 100 can reduce the sense of disharmony the user may feel by further performing the process illustrated in FIG. 10, for example, in addition to the process illustrated in FIG. 6.

The display control device 100 according to this embodiment can reduce the sense of disharmony the user may feel by performing the process related to the display control method according to this embodiment, for example, illustrated in FIG. 6 or FIGS. 6 and 10.

The process related to the display control method according to this embodiment is not limited to the process illustrated in FIG. 6 or 10. For example, although the display control device 100 determines whether or not to reverse the image on the basis of the process result of step S106 in FIG. 6 or determines whether or not to reverse the audio on the basis of the process result of step S206 in FIG. 10, the display control device 100 may determine whether to not to reverse the image or the audio on the basis of process execution setting information indicating whether or not to reverse the image or audio. Here, although the display control device 100 acquires the above-described process execution setting information from the display device 20, for example, by transmitting a process execution setting information transmission request for requesting the transmission of the process execution setting information to the display device 20, a method of acquiring the process execution setting information is not limited to the above. For example, the display control device 100 may store the process execution setting information transmitted from the display device 20 in a storage section (not illustrated) or the like on the basis of an operation of the user of the display device 20, regardless of the above-described process execution setting information transmission request, and use the process execution setting information stored in a storage section (not illustrated).

Next, a configuration of the display control device 100 according to this embodiment capable of performing a process related to the display control method according to this embodiment described above will be described.

(Example of Configuration of Display Control Device 100)

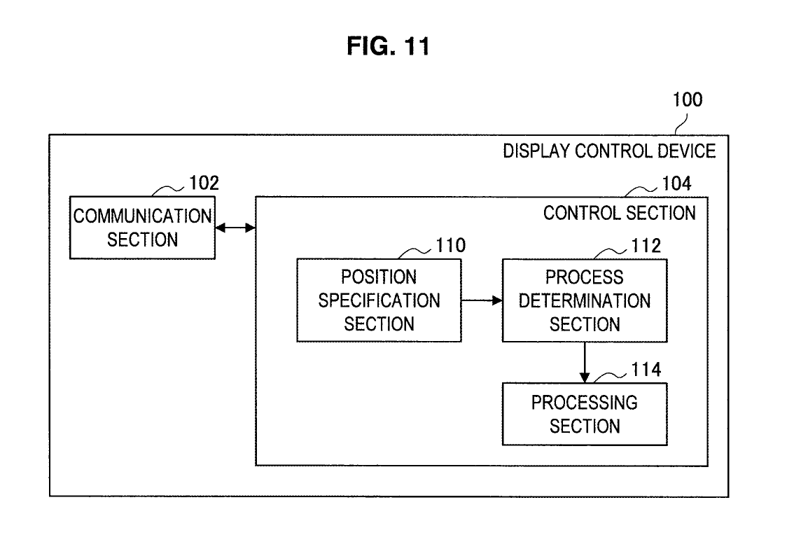

FIG. 11 is a block diagram illustrating the example of the configuration of the display control device 100 according to this embodiment. The display control device 100 includes, for example, a communication section 102 and a control section 104.

In addition, the display control device 100 may include, for example, a read only memory (ROM) (not illustrated) or a random access memory (RAM) (not illustrated), a storage section (not illustrated), an operation section (not illustrated) capable of being operated by the user of the display control device 100, a display section (not illustrated) that displays various screens on a display screen, and the like. The display control device 100 establishes a connection between the above-described components by a bus, for example, as a transmission path for data.

The ROM (not illustrated) stores programs to be used by the control section 104 and control data such as arithmetic parameters. The RAM (not illustrated) temporarily stores programs and the like to be executed by the control section 104. The storage section (not illustrated) is a storage means provided in the display control device 100. Here, a recording medium to be described later is included as an example of the storage section (not illustrated). In addition, an operation device to be described later is included as an example of the operation section (not illustrated), and a display device to be described later is included as an example of the display section (not illustrated).

<Hardware Configuration Example of Display Control Device 100>

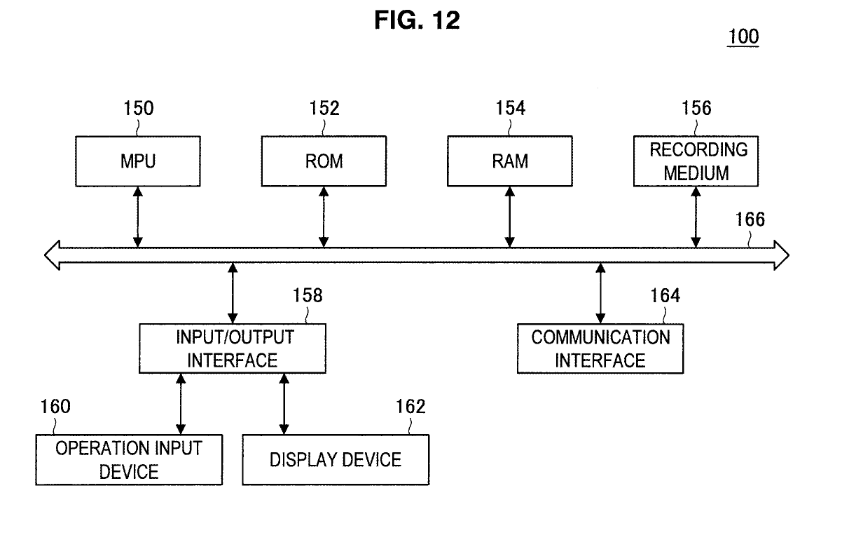

FIG. 12 is an explanatory diagram showing the hardware configuration example of the display control device 100. The display control device 100 includes, for example, a micro processing unit (MPU) 150, a ROM 152, a RAM 154, a recording medium 156, an input/output interface 158, an operation input device 160, a display device 162, and a communication interface 164. In addition, the display control device 100 establishes a connection between the above-described components by a bus 166, for example, as a transmission path for data.

The MPU 150 is constituted, for example, by an integrated circuit into which various circuits are integrated to implement an MPU or control function, or the like, and functions as the control section 104 that controls the entire display control device 100. In the display control device 100, the MPU 150 can function as a position specification section 110, a processing determination section 112, and a processing section 114 to be described later.

The ROM 152 stores, for example, programs to be used by the MPU 150 and control data such as arithmetic parameters, and the RAM 154 primarily stores, for example, programs and the like to be executed by the MPU 150.

The recording medium 156 is a storage means included in the display control device 100, and functions as a storage section (not illustrated). The recording medium 156 stores, for example, various DBs such as a DB in which IP addresses are associated with positions, applications, or the like. A magnetic recording medium such as a hard disk, a nonvolatile memory such as a flash memory, magnetoresistive RAM (MRAM), or ferroelectric RAM (FeRAM), and the like are included as an example of the recording medium 156. In addition, the recording medium 156 may be attachable to or detachable from the display control device 100.

The input/output interface 158 is connected to, for example, the operation input device 160 or the display device 162. The operation input device 160 functions as an operation section (not illustrated), and the display device 162 functions as a display section (not illustrated). Here, a universal serial bus (USB) terminal, a digital visual interface (DVI) terminal, a high-definition multimedia interface (HDMI) terminal, various processing circuits, and the like are included as examples of the input/output interface 160. The operation input device 160 is provided, for example, on the display control device 100, and is connected to the input/output interface 158 inside the display control device 100. In addition, a button, a direction key, a rotary selector such as a jog dial, or a combination thereof is included as an example of the operation input device 160. The display device 162 is provided, for example, on the display control device 100, and is connected to the input/output interface 158 inside the display control device 100. A liquid crystal display (LCD), an organic electroluminescence (EL) display (which is also referred to as an organic light emitting diode (OLED) display), and the like are included as examples of the display device 162. Needless to say, the input/output interface 158 can be connected to an operation input device (for example, a keyboard, a mouse, or the like) or a display device (for example, an external display or the like) as an external device of the display control device 100. In addition, the display device 162 may be a device on which a display and the user's operation are possible, for example, such as a touch screen.

The communication interface 166 is a communication means provided in the display control device 100, and functions as the communication section 102 for performing wireless communication with an external device via the networks 500 and 600 (or directly). Here, an IEEE 802.11n port and a transmission/reception circuit, a communication antenna and a radio frequency (RF) circuit, or the like are included as an example of the communication interface 166. The communication interface 166 according to this embodiment is not limited to the above. For example, a communication device corresponding to the networks 500 and 600 is included as an example of the communication interface 166.

The display control device 100 performs the process related to the display control method according to this embodiment described above (for example, the above-described process (A) (the process of specifying the positions of the imaging device and the display device) to the above-described process (C) (the process of selectively reversing the image in the horizontal direction and causing the display device to display the selectively reversed image), for example, according to the configuration illustrated in FIG. 12.

The configuration of the display control device 100 according to this embodiment is not limited to the configuration illustrated in FIG. 12. For example, the display control device 100 may function as an audio output means, and further include an audio output device including a digital signal processor (DSP), an amplifier (AMP) or a speaker, and the like.

In addition, the display control device 100 may further include, for example, a position detection device that functions as a position detection means (position detection section) for detecting the position of the display control device 100. A communication antenna, which receives a signal transmitted from an external device such as a global positioning system (GPS) satellite, a processing circuit, which processes a received signal and specifies a position, and the like are included as an example of the position detection device. The above-described communication antenna may be shared with the communication interface 166. In addition, the position detection device is not limited to the above-described GPS-related device. A processing circuit for implementing any process capable of specifying a position such as a processing circuit for specifying the position using a DB in which IP addresses are associated with positions is included as an example of the position detection device according to this embodiment.

An example of the configuration of the display control device 100 will be described with reference back to FIG. 11. The communication section 102 is a communication means provided in the display control device 100, and functions to perform wireless communication with an external device via the networks 500 and 600 (or directly). Here, an IEEE 802.11n port and a transmission/reception circuit, a communication antenna and an RF circuit, or the like are included as an example of the communication section 102.

The control section 104 includes, for example, an MPU and the like, and functions to control the entire display control device 100. In addition, the control section 104 includes, for example, the position specification section 110, the process determination section 112, and the processing unit 114, and functions to initiatively perform a process related to the display control method according to this embodiment described above.

The position specification section 110 initiatively functions to perform the above-described process (A) (the process of specifying the positions of the imaging device and the display device). More specifically, the position specification section 110 performs the process illustrated in steps S100 and S102, for example, illustrated in FIG. 6, and specifies the positions of the imaging device 10 and the display device 20.

The process determination section 112 functions to initiatively perform the above-described process (B) (the process of determining whether or not to reverse the image in the horizontal direction). More specifically, the process determination section 112 performs, for example, the process illustrated in steps S104 to S108 illustrated in FIG. 6, using the positions of the image device 10 and the display device 20 delivered from the position specification section 110, and determines whether or not to reverse the image captured by the selected imaging device 10 in the horizontal direction. The process determination section 112 may determine whether or not to reverse the image in the horizontal direction, for example, on the basis of process execution setting information indicating whether or not to reverse the image.

In addition, when there are audio signals of a plurality of channels indicating audios corresponding to an image captured by the selected imaging device 10, the process determination section 112 can perform, for example, the process illustrated in steps S204 to S208 illustrated in FIG. 10, and further determine whether or not to reverse a first-channel audio signal and a second-channel audio signal among the audios corresponding to the above-described image (whether or not to left/right reverse the audio). The process determination section 112 may determine whether or not to left/right reverse the audio, for example, on the basis of the process execution setting information indicating whether or not to reverse the audio.

The processing section 114 functions to initiatively perform the above-described process (C) (the process of selectively reversing the image in the horizontal direction and causing the display device to display the selectively reversed image). More specifically, the image indicated by the image signal transmitted from the imaging device 10 is selectively reversed in the horizontal direction on the basis of the determination result delivered from the process determination section 112. When the image has been reversed in the horizontal direction, the processing section 114 transmits the image signal indicating the reversed image to the display device 20 of the transmission destination of the image signal transmitted from the imaging device 10 via the communication section 102, and causes the display device 20 to display the reversed image. In addition, when the image is not reversed in the horizontal direction, the processing section 114 transmits the image signal transmitted from the imaging device 10 to the display device 20 of the transmission destination described above, and causes the display device 20 to display the image indicated by the image signal.

In addition, if a determination result indicating whether or not to reverse a first-channel audio signal and a second-channel audio signal has been further delivered from the process determination section 112, the processing section 114 selectively reverses the first-channel audio signal and the second-channel audio signal among the audio signals corresponding to the image indicated by the image signal transmitted from the imaging device 10 on the basis of the determination result delivered from the process determination section 112. When reversing the first-channel audio signal and the second-channel audio signal, the processing section 114 transmits the channel-reversed audio signals to the display device 20 of the transmission destination of the image signal transmitted from the imaging device 10 via the communication section 102, and causes the display device to reproduce the reversed audios. In addition, when not reversing the first-channel audio signal and the second-channel audio signal, the processing section 114 transmits the audio signal corresponding to the image indicated by the image signal transmitted from the image device 10 to the display device 20 of the transmission destination of the image signal transmitted from the image device 10 via the communication section 102, and causes the display device 20 to reproduce the audio indicated by the audio signal.

The control section 104 initiatively performs the process related to the display control method according to this embodiment described above, for example, by including the position specification section 110, the process determination section 112, and the processing section 114. Of course, a configuration for implementing the process related to the display control method according to this embodiment in the display control device 100 is not limited to the configuration of the control section 104 illustrated in FIG. 11.

The display control device 100 can perform the process related to the display control method according to this embodiment as illustrated in FIG. 6 or FIGS. 6 and 10, for example, according to the configuration illustrated in FIG. 11. Therefore, the display control device 100 can reduce the sense of disharmony the user may feel, for example, according to the configuration illustrated in FIG. 11.

The configuration of the display control device 100 according to this embodiment is not limited to the configuration illustrated in FIG. 11. For example, the display control device 100 can be applied to the imaging device or the display device constituting the display control system according to this embodiment. Other configuration examples of the display control device 100 according to this embodiment will be described with reference to the display control system 2000 according to the second embodiment and the display control system 3000 according to the third embodiment to be described later.

Next, an example of configurations of the imaging device 10 and the display device 20 constituting the display control system 1000 according to the first embodiment will be described.

[Imaging Device 10]

The imaging device 10 includes, for example, an imaging section (not illustrated), a communication section (not illustrated), and a control section (not illustrated), and captures an image and transmits an image signal to the display device 20 that handles the transmission. In addition, the imaging device 10 may include, for example, a ROM (not illustrated), a RAM (not illustrated), a storage section (not illustrated), or the like. The imaging device 10 establishes a connection between the above-described components by a bus, for example, as a transmission path for data.

Here, the ROM (not illustrated) stores programs to be used by the control section (not illustrated) and control data such as arithmetic parameters. In addition, the RAM (not illustrated) temporarily stores programs and the like to be executed by the control section (not illustrated).

The storage section (not illustrated) is a storage means provided in the imaging device 10, and stores, for example, link information for connecting to the display device 20, position information for identifying a position of each device such as the imaging device 10 or the display device 20, and various data such as an application. Here, a magnetic recording medium such as a hard disk or a non-volatile memory such as a flash memory is included as an example of the storage section (not illustrated).

The imaging section (not illustrated) captures an image. Here, an imaging device including a lens-imaging element and a signal processing circuit is included as an example of the imaging section (not illustrated). The lens-imaging element is constituted by an image sensor using a lens of an optical system and a plurality of imaging elements, for example, such as a charge coupled device (CCD) or a complementary metal oxide semiconductor (CMOS). In addition, the signal processing circuit includes, for example, an automatic gain control (AGC) circuit or an analog to digital converter (ADC), converts an analog signal generated by the imaging element into a digital signal (image data), and processes various signals. In addition, a white balance correction process, a color tone correction process, a gamma correction process, a YCbCr conversion process, an edge enhancement process, and the like are included as examples of signal processing to be performed by the signal processing circuit.

The communication section (not illustrated) is a communication means provided in the imaging device 10, and communicates with an external device via the network 500 (or directly). Here, a communication device corresponding to the network 500 is included as the communication section (not illustrated).

The control section (not illustrated) includes an MPU or various processing circuits, and functions to control the entire imaging device 10. In addition, the control section (not illustrated) controls communication with the external device in the communication section (not illustrated). Here, path control, quality of service (QoS)-related control, transmission timing control of an image signal with the display device 20 of an object to which the image signal is transmitted, and the like are included as examples of communication control in the control section (not illustrated).

More specifically, if a transmission initiation instruction signal transmitted from the display device 20 has been delivered from the communication section (not illustrated), the control section (not illustrated) causes image data generated by capturing of the imaging section (not illustrated) to be transmitted according to imaging at a transmission initiation time specified by the transmission initiation instruction signal. In addition, when causing the image data to be transmitted, the control section (not illustrated) performs an encoding process in a predetermined coding scheme such as line-based coding (or causes another component to perform the encoding process).

In addition, the control section (not illustrated) causes position information to be transmitted to the display control device 100, or causes the position information to be periodically/aperiodically transmitted to the display control device 100, for example, if a position information transmission request transmitted from the display control device 100 has been received.

The imaging device 10 has, for example, the configuration as described above. The configuration of the imaging device 10 is not limited to the above. For example, the imaging device 10 may further include a sound collection device including a microphone or the like, and further transmit an audio signal corresponding to a captured image.

[Display Device 20]

The display device 20 includes, for example, a display section (not illustrated), a communication section (not illustrated), and a control section (not illustrated), and displays an image indicated by an image signal received by the communication section (not illustrated) on a display screen. In addition, the display device 20 may include, for example, a ROM (not illustrated), a RAM (not illustrated), a storage section (not illustrated), or the like. The display device 20 establishes a connection between the above-described components by a bus, for example, as a transmission path for data.

Here, the ROM (not illustrated) stores programs to be used by the control section (not illustrated) and control data such as arithmetic parameters. In addition, the RAM (not illustrated) temporarily stores programs and the like to be executed by the control section (not illustrated).

The storage section (not illustrated) is a storage means provided in the display device 20, and stores, for example, link information for connecting to the imaging device 10, position information for identifying a position of the display device 20, and various data such as an application. Here, a magnetic recording medium such as a hard disk or a non-volatile memory such as a flash memory is included as an example of the storage section (not illustrated).

The display section (not illustrated) is a display means provided in the display device 20, and displays various information on the display screen. A reproduction screen on which an image obtained by decoding an image signal received by the communication section (not illustrated) is displayed, screens as illustrated in FIGS. 7 and 9, an operation screen for performing a desired operation on the display device 20, and the like are included as examples of the screen displayed on the display screen of the display device 20. Here, an LCD, an organic EL device, and the like are included as examples of the display section (not illustrated). In addition, the display device 20 can constitute the display section (not illustrated), for example, by a touch screen. In the above-described case, the display section (not illustrated) functions as an operation display section through which both the user's operation and a display are possible.

The communication section (not illustrated) is a communication means provided in the display device 20, and communicates with an external device via the network 600 (or directly). Here, a communication device corresponding to the network 600 is included as the communication section (not illustrated).

For example, the communication section (not illustrated) reads data stored in a transmission memory such as a RAM, generates a transmission packet (for example, an IP packet when communication based on an IP protocol is performed), and transmits the generated IP packet. In addition, when receiving a packet, the communication section (not illustrated) analyzes the received packet, separates the packet, for example, into data of an object to be processed such as image data and control data for use in various controls such as communication control, and records the data after separation on a RAM or the like. For example, when performing communication based on the IP protocol, the communication section (not illustrated) records image data or the like on a reception memory such as a RAM by referring to a destination IP address and a destination port number included in the received packet. The communication section (not illustrated) may have a routing function of controlling the transmission of data to another device.

The control section (not illustrated) is constituted by an MPU, various processing circuits, or the like, and functions to control the entire display device 20. In addition, the control section (not illustrated) controls communication with an external device in the communication section (not illustrated), and performs a reproduction process such as synchronization control related to reproduction of an image, an audio, or the like or decoding of image data or the like.

The control section (not illustrated) controls communication with an external device in the communication section (not illustrated). In addition, the control section (not illustrated) determines when decoding should be initiated (for example, a decoding initiation time), reads data serving as an object to be decoded from the reception memory, and decodes the read data.

Here, path control, QoS-related control, or the like is included as an example of control of communication in the control section (not illustrated). In addition, the control section (not illustrated) manages an input/output of image data to/from an application related to the transmission of image data, for example, such as an image data transmission request. Here, although the above-described process in the control section (not illustrated) is implemented, for example, as a process of an application layer, an implementation method is not limited to the above.

In addition, the control section (not illustrated) adjusts transmission/reception timing of image data according to communication with the imaging device 10 via the communication section (not illustrated), and determines when the decoding should be initiated. For example, the control section (not illustrated) starts to adjust transmission/reception timing of image data using a synchronization request signal transmitted from the imaging device 10 and received by the communication section (not illustrated) as a trigger. The control section (not illustrated) transmits a transmission initiation instruction signal specifying a transmission initiation time of image data for the imaging device 10, and designates a time corresponding to the transmission initiation time as the decoding initiation time. Here, the control section (not illustrated) designates a time, for example, obtained by subtracting a time for absorbing a delay caused by fluctuation in a data amount for each decoding unit or fluctuation in a communication environment such as jitter of a communication path, a hardware delay, or a memory delay from the decoding initiation time, as a transmission initiation time of image data.

The control section (not illustrated) acquires the synchronization related to transmission/reception of image data to/from the imaging device 10 by adjusting transmission/reception timing of the image data as described above and determining when decoding should be initiated. Here, although a process related to synchronization in the control section (not illustrated) is implemented, for example, as a process of an application layer, an implementation method is not limited to the above.

In addition, the control section (not illustrated) decodes data read from the reception memory in units of N lines (N is greater than or equal to 1) within one field, for example, on the basis of a line-based codec. The control section (not illustrated) causes the display section (not illustrated) to display an image indicated by the decoded image data. Of course, a decoding process in the display device 20 is not limited to a process based on the line-based codec.

In addition, the control section (not illustrated) causes position information to be transmitted to the display control device 100, or causes the position information to be periodically/aperiodically transmitted to the display control device 100, for example, if a position information transmission request transmitted from the display control device 100 has been received.

The display device 20 has, for example, the configuration as described above. According to the configuration as described above, the display device 20 can implement the transmission of image data with a small delay and implement the synchronization related to transmission/reception of image data to/from the imaging device 10 in the display control system 1000.

The configuration of the display device 20 is not limited to the above. For example, the display device 20 may have a function of encoding image data in a predetermined encoding unit or a function of transmitting the encoded image data to another device according to a predetermined image compression scheme such as a line-based codec. In addition, the display device 20 may further include an audio output section (not illustrated), which outputs an audio. An audio output device including a DSP, an AMP or a speaker, and the like is included as an example of the audio output section (not illustrated).

The display control system 1000 according to the first embodiment has, for example, the display control device 100, the imaging device 10, and the display device 20 having the configurations as described above. Here, the display control device 100 performs the process related to the display control method according to this embodiment, for example, as illustrated in FIG. 6 or FIGS. 6 and 10, thereby causing the horizontal axis in the object the user directly views to be consistent with the horizontal axis in the object the user indirectly views via the image reflected on the display screen of the display device.

Therefore, the display control system 1000 according to the first embodiment has the display control device 100, thereby reducing the sense of disharmony the user may feel.

In addition, although the display control device 100 has been described above as a component constituting the display control system 1000 according to the first embodiment, this embodiment is not limited to this type. This embodiment can be applied to various devices having a communication function, for example, including a computer such as a PC or a server.

(2) Display Control System According to Second Embodiment

A configuration in which the display control device 100 separated from the imaging device or the display device selectively reverses an image captured by the imaging device in the horizontal direction and causes the display device to display the image as the display control system 1000 according to the first embodiment has been shown above. However, the configuration of the display control system according to this embodiment is not limited to the configuration related to the display control system 1000 according to the first embodiment, for example, as illustrated in FIG. 5. For example, in the display control system according to this embodiment, the display device, which displays an image, can function as the display control device according to this embodiment. Next, the display control system in which the display device functions as the display control device according to this embodiment will be described as the display control system 2000 according to the second embodiment.

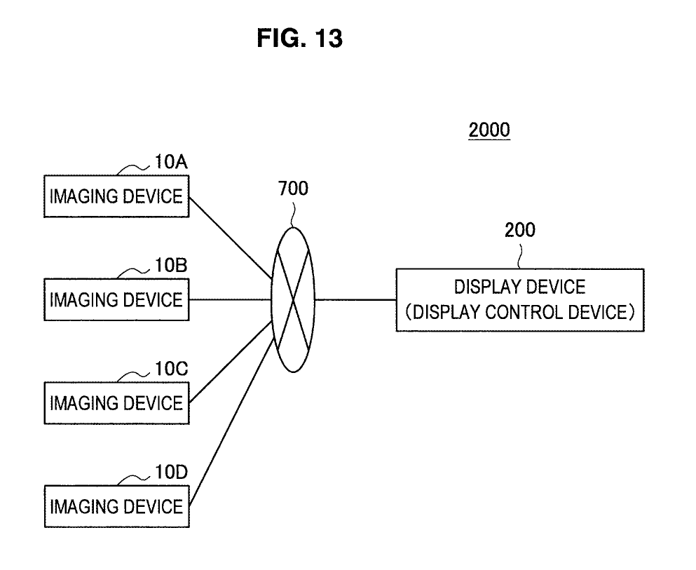

FIG. 13 is an explanatory diagram illustrating an example of a configuration of the display control system 2000 according to the second embodiment. The display control system 2000 has a display device 200, which functions as the display control device according to this embodiment, and imaging devices 10A to 10D. In addition, the display device 200 and the imaging devices 10A to 10D are each connected to a network 700. Here, the same network as the network 500 or 600 illustrated in FIG. 5 is included as an example of the network 700.

Although a configuration in which the display control system 2000 has the four imaging devices 10A to 10D is illustrated in FIG. 13, the configuration of the display control system 2000 according to the second embodiment is not limited to the above. For example, the display control system 2000 according to the second embodiment may have one or more imaging devices 10. In addition, although a configuration in which the display control system 2000 has one display device 200 is illustrated in FIG. 13, the configuration of the display control system 2000 according to the second embodiment is not limited to the above. For example, the display control system 2000 according to the second embodiment may have a plurality of display devices 200. When the plurality of display devices 200 are provided, each display device 200 has a configuration as will be described later in the display control system 2000, thereby performing a process related to the display control method according to this embodiment and displaying an image.

The display device 200 further has a function provided in the display control device 100 according to the first embodiment, for example, in addition to a function provided in the display device 20 according to the first embodiment.

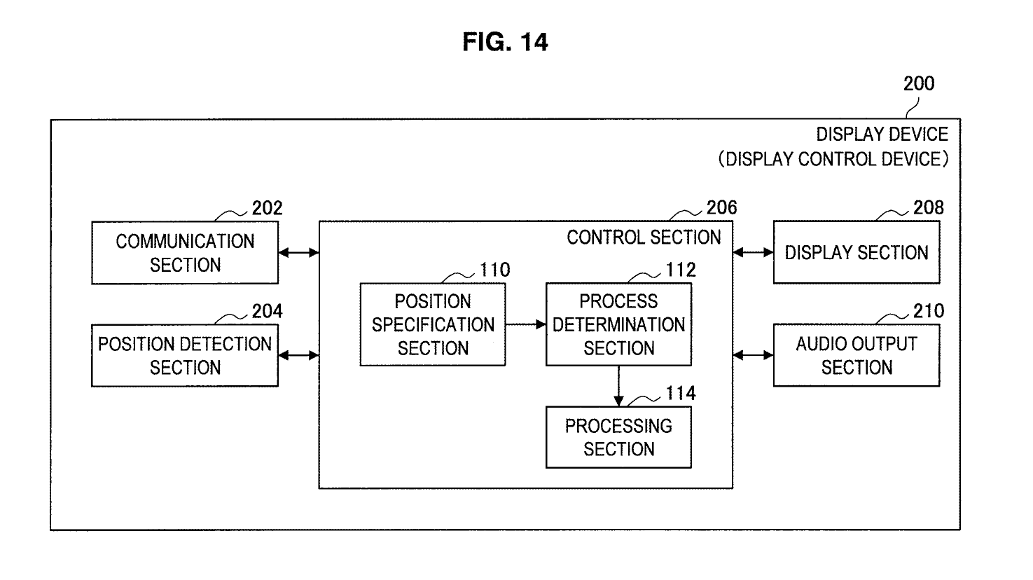

FIG. 14 is a block diagram illustrating an example of a configuration of the display device 200 according to this embodiment. The display device 200 (display control device) includes, for example, a communication section 202, a position detection section 204, a control section 206, a display section 208, and an audio output section 210.

In addition, the display device 200 may include, for example, a ROM (not illustrated) or a RAM (not illustrated), a storage section (not illustrated), an operation section (not illustrated) capable of being operated by the user of the display device 200, and the like. The display device 200 establishes a connection between the above-described components by a bus, for example, as a transmission path for data.

The ROM (not illustrated) stores programs to be used by the control section 206 and control data such as arithmetic parameters. The RAM (not illustrated) temporarily stores programs and the like to be executed by the control section 206.

The storage section (not illustrated) is a storage means provided in the display device 200. Here, a magnetic recording medium such as a hard disk or a non-volatile memory such as a flash memory is included as an example of the storage section (not illustrated). In addition, the above-described operation device is included as an example of the operation section (not illustrated).

<Hardware Configuration Example of Display Device 200>

The display device 200 has, for example, the same hardware configuration as the display control device 100 illustrated in FIG. 12. Here, an MPU 150 illustrated in FIG. 12 functions as the control section 206. In addition, the MPU 150 can function as the position specification section 110, the process determination section 112, and the processing section 114 in the display device 200. In addition, the display device 162 illustrated in FIG. 12 functions as the display section 208. In addition, the communication interface 164 illustrated in FIG. 12 functions as the communication section 202.

In addition, the display device 200 may further include, for example, a position detection device, which functions as the position detection section 204, and an audio output device, which functions as the audio output section 210, for example, in addition to the hardware configuration illustrated in FIG. 12. The hardware configuration of the display device 200 according to this embodiment is not limited to the configuration further including the position detection device. For example, in the display device 200, the MPU 150 or the MPU 150 and the communication interface 164 may function as the position detection device.

The communication section 202 is a communication means provided in the display device 200, and functions to perform wireless communication with an external device via the network 700 (or directly). Here, an IEEE 802.11n port and a transmission/reception circuit, a communication antenna and an RF circuit, or the like are included as an example of the communication section 202.

The position detection section 204 detects a position of its own device. Here, the position detection section 204 detects the position of its own device, for example, by performing a process related to a position specification method based on the above-described position information. In addition, the position detection section 204 may detect the position of its own device in cooperation with the position specification section 110. Although the above-described position detection device is included as an example of the position detection section 204, the configuration of the position detection section 204 is not limited to the above.

The control section 206 is constituted, for example, by an MPU, and functions to control the entire display device 200. In addition, the control section 206 includes the position specification section 110, the process determination section 112, and the processing section 114, for example, having the same functions as the control section 104 of the display control device 100 according to the first embodiment illustrated in FIG. 11, and functions to initiatively perform the process related to a display control method according to this embodiment described above (for example, the above-described process (A) (the process of specifying the positions of the imaging device and the display device) to the above-described process (C) (the process of selectively reversing the image in the horizontal direction and causing the display device to display the selectively reserved image)).

More specifically, for example, if the process determination section 112 determines to reverse the image in the horizontal direction, the processing section 114 reverses the image indicated by the image signal received by the communication section 202 in the horizontal direction. The processing section 114 causes the display section 208 to display the image reversed in the horizontal direction, for example, by delivering the image signal indicating the image reversed in the horizontal direction to the display section 208. In addition, for example, if the process determination section 112 determines that the image is not reversed in the horizontal direction, the processing section 114 causes the display section 208 to display the image indicated by the image signal received by the communication section 202, for example, by delivering the image signal received by the communication section 202 to the display section 208.

In addition, like the processing section 114 of the display control device 100 according to the first embodiment illustrated in FIG. 11, the processing section 114 may selectively reverse a first-channel audio signal and a second-channel audio signal among audio signals corresponding to the image indicated by the image signal transmitted from the imaging device 10 on the basis of a determination result delivered from the process determination section 112. When the first-channel audio signal and the second-channel audio signal have been reversed, the processing section 114 reproduces the channel-reversed audio signals and causes the audio output section 210 to output audios indicated by the audio signals. In addition, when the first-channel audio signal and the second-channel audio signal are not reversed, the processing section 114 reproduces the audio signals corresponding to the image indicated by the image signal transmitted from the imaging device 10 and causes the audio output section 210 to output audios indicated by the audio signals.

In addition, the control section 206 has the same configuration as the display device 20 according to the first embodiment, thereby implementing the transmission of image data with a small delay and implementing the synchronization related to transmission/reception of image data to/from the imaging device 10 in the display control system 2000

The control section 206 includes the position specification section 110, the process determination section 112, and the processing section 114, for example, having the same functions as the control section 104 of the display control device 100 according to the first embodiment illustrated in FIG. 11, thereby initiatively performing the process related to the display control method according to this embodiment described above. Of course, a configuration for implementing the process related to the display control method according to this embodiment in the display device 200 is not limited to the configuration of the control section 206 illustrated in FIG. 14.

The display section 208 is a display means provided in the display device 200, and displays various information on the display screen. A reproduction screen on which the image obtained by decoding the image signal received by the communication section 202 is displayed, screens as illustrated in FIGS. 7 and 9, an operation screen for performing a desired operation on the display device 200, and the like are included as examples of the screen displayed on the display screen of the display device 200. Here, an LCD, an organic EL device, or the like is included as an example of the display section 208. In addition, the display device 200 can constitute the display section 208, for example, by a touch screen. In the above-described case, the display section 208 functions as an operation display section through which both the user's operation and a display are possible.

The audio output section 210 is an audio output means provided in the display device 200, and outputs various audios. An audio indicated by an audio signal corresponding to a received image signal, audios indicated by audio signals obtained by reversing a first-channel audio signal and a second-channel audio signal in the processing section 114, a system audio such as an audio for a notification of an error, and the like are included as examples of an audio output from the audio output section 210. Here, an audio output device including an AMP or a speaker, and the like are included as an example of the audio output section 210.

For example, like the display control device 100 according to the first embodiment illustrated in FIG. 11, the display device 200 can perform the process related to the display control method according to this embodiment, for example, according to a configuration illustrated in FIG. 14. Therefore, the display device 200 can reduce the sense of disharmony the user may feel, for example, according to the configuration illustrated in FIG. 14.

The configuration of the display device 200 according to the second embodiment is not limited to the configuration illustrated in FIG. 14. For example, the display device 200 may cause an external audio output device, for example, such as an external speaker, to output an audio, without the audio output section 210 illustrated in FIG. 14. In addition, the display device 200 may cause an external display device, for example, such as the external display, to display an image, without the display section 208 illustrated in FIG. 14. Of course, the display device 200 can cause the external display device, for example such as the external display, to display the image, regardless of whether or not the display device 200 is provided with the display section 208.

The display control system 2000 according to the second embodiment has the display device 200, which functions as the display control device according to this embodiment, and the imaging device 10, for example, as illustrated in FIG. 13. Here, the display device 200 performs the process related to the display control method according to this embodiment, for example, as illustrated in FIG. 6 or FIGS. 6 and 10, thereby causing the horizontal axis in the object the user directly views to be consistent with the horizontal axis in the object the user indirectly views via the image reflected on the display screen of the display device.

Therefore, the display control system 2000 according to the second embodiment has the display device 200, thereby reducing the sense of disharmony the user may feel.

In addition, although the display control device 200 has been described above as a component constituting the display control system 2000 according to the second embodiment, this embodiment is not limited to this type. This embodiment can be applied to various devices, for example, including a computer such as a PC or a server, a portable communication device such as a portable phone or a personal handy-phone system (PHS), a video/music reproduction device, a video/music recording/reproduction device, and a game machine.

(3) Display Control System According to Third Embodiment

A configuration in which the display control device 100 separated from the imaging device or the display device causes the display device to display an image by selectively reversing the image captured by the imaging device as the display control system 1000 according to the first embodiment has been shown above, and a configuration in which the display device functions as the display control device according to this embodiment as the display control system 2000 according to the second embodiment has been described above. However, the configuration of the display control system according to this embodiment is not limited to the configuration related to the display control system 1000 according to the first embodiment, for example, as illustrated in FIG. 5 or the configuration related to the display control system 2000 according to the second embodiment, for example, as illustrated in FIG. 13. For example, in the display control system according to this embodiment, the imaging device, which captures an image, can function as the display control device according to this embodiment. Next, the display control system in which the display device functions as the display control device according to this embodiment will be described as the display control system 3000 according to the third embodiment.

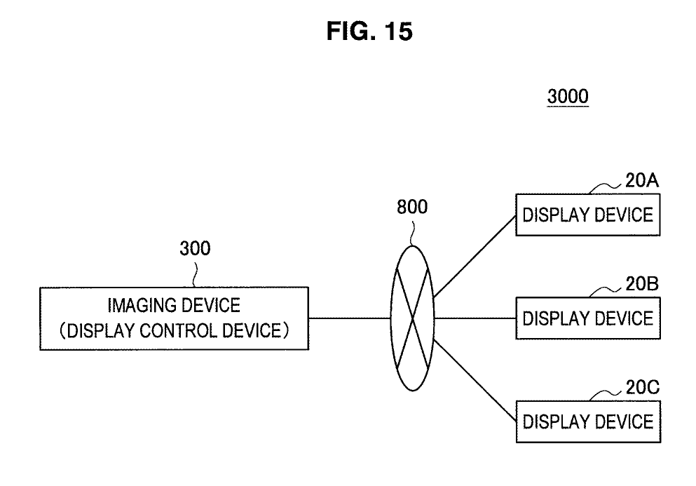

FIG. 15 is an explanatory diagram illustrating an example of a configuration of the display control system 3000 according to the third embodiment. The display control system 3000 has an imaging device 300, which functions as the display control device according to this embodiment, and display devices 20A to 20C. In addition, the imaging device 300 and the display devices 20A to 20C are each connected to a network 800. Here, the same network as the network 500 or 600 illustrated in FIG. 5 is included as an example of the network 800.

Although a configuration in which the display control system 3000 has the three display device 20A to 20C is illustrated in FIG. 15, the configuration of the display control system 3000 according to the third embodiment is not limited to the above. For example, the display control system 3000 according to the third embodiment may have one or more display devices 20. In addition, although a configuration in which the display control system 3000 has one imaging device 300 is illustrated in FIG. 15, the configuration of the display control system 3000 according to the third embodiment is not limited to the above. For example, the display control system 3000 according to the third embodiment may have a plurality of imaging devices 300. When the plurality of imaging devices 300 are provided, each imaging device 300 has a configuration as will be described later in the display control system 3000, thereby performing a process related to the display control method according to this embodiment and performing the capture of an image and the transmission of an image signal.

The imaging device 300 further has a function provided in the display control device 100 according to the first embodiment, for example, in addition to the function provided in the imaging device 10 according to the first embodiment.

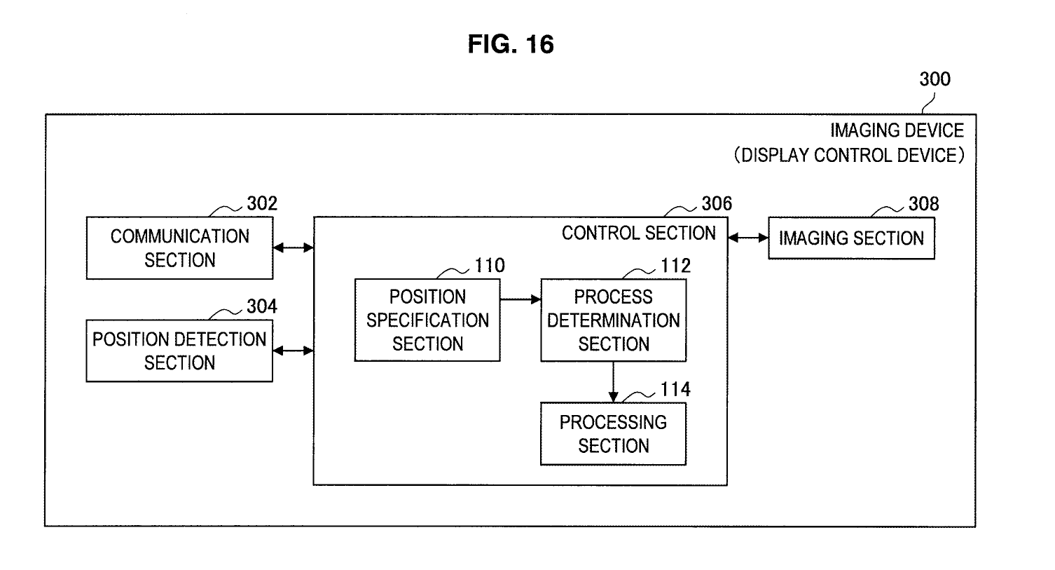

FIG. 16 is a block diagram illustrating an example of a configuration of the imaging device 300 according to this embodiment. The imaging device 300 (display control device) includes, for example, a communication section 302, a position detection section 304, a control section 306, and an imaging section 308.

In addition, the imaging device 300 may include, for example, a ROM (not illustrated) or a RAM (not illustrated), a storage section (not illustrated), an operation section (not illustrated) capable of being operated by the user of the imaging device 300, an audio signal generation section (not illustrated), which generates an audio signal, and the like. The imaging device 300 establishes a connection between the above-described components by a bus, for example, as a transmission path for data.

The ROM (not illustrated) stores programs to be used by the control section 306 and control data such as arithmetic parameters. The RAM (not illustrated) temporarily stores programs and the like to be executed by the control section 306.

The storage section (not illustrated) is a storage means provided in the imaging device 300. Here, a magnetic recording medium such as a hard disk or a non-volatile memory such as a flash memory is included as an example of the storage section (not illustrated). In addition, a sound collection device including a microphone and the like are included as an example of the audio signal generation section (not illustrated).

<Hardware Configuration Example of Imaging Device 300>

The imaging device 300 has, for example, the same hardware configuration as the display control device 100 illustrated in FIG. 12. Here, the MPU 150 illustrated in FIG. 12 functions as the control section 306. In addition, the MPU 150 can function as the position specification section 110, the process determination section 112, and the processing section 114 in the imaging device 300. In addition, the communication interface 164 illustrated in FIG. 12 functions as the communication section 302.

In addition, the imaging device 300 further includes, for example, an imaging device that functions as the imaging section 308, for example, in addition to the hardware configuration illustrated in FIG. 12. In addition, the imaging device 300 may further include a position detection device that functions as the position detection section 304, for example, in addition to the hardware configuration illustrated in FIG. 12. The hardware configuration of the imaging device 300 according to this embodiment is not limited to a configuration further including the position detection device. For example, in the imaging device 300, the MPU 150 or the MPU 150 and the communication interface 164 may function as the position detection device.

The communication section 302 is a communication means provided in the imaging device 300, and functions to perform wireless communication with an external device via the network 800 (or directly). Here, an IEEE 802.11n port and a transmission/reception circuit, a communication antenna and an RF circuit, or the like are included as an example of the communication section 302.

The position detection section 304 detects a position of its own device. Here, the position detection section 304 detects a position of its own device, for example, by performing a process related to the position specification method based on the above-described position information. In addition, the position detection section 304 may detect the position of its own device in cooperation with the position specification section 110. Although the above-described position detection device is included as an example of the position detection section 304, the configuration of the position detection section 304 is not limited to the above.

The control section 306 is constituted, for example, by an MPU or the like, and functions to control the entire imaging device 300. In addition, the control section 306 includes the position specification section 110, the process determination section 112, and the processing section 114, for example, having the same functions as the control section 104 of the display control device 100 according to the first embodiment illustrated in FIG. 11, and functions to initiatively perform the process related to the display control method according to this embodiment described above (for example, the above-described process (A) (the process of specifying the positions of the imaging device and the display device) to the above-described process (C) (the process of selectively reversing the image in the horizontal direction and causing the display device to display the selectively reserved image)).

More specifically, for example, when the process determination section 112 determines to cause the image to be reversed in the horizontal direction, the processing section 114 reverses the image captured by the imaging section 308 in the horizontal direction. The processing section 114 causes an image signal indicating the image reversed in the horizontal direction to be transmitted to the display device 20 of a transmission object, for example, by delivering a transmission command and the image signal indicating the image reversed in the horizontal direction to the communication section 302. In addition, for example, when the process determination section 112 determines not to cause the image to be reversed in the horizontal direction, the processing section 114 causes the image signal to be transmitted to the display device 20 of the transmission object, for example, by delivering the transmission command and the image signal indicating the image captured by the imaging section 308 to the communication section 302.

In addition, like the processing section 114 of the display control device 100 according to the first embodiment illustrated in FIG. 11, the processing section 114 may selectively reverse the first-channel audio signal and the second-channel audio signal among audio signals corresponding to the image indicated by the image signal transmitted from the imaging device 10 on the basis of the determination result delivered from the process determination section 112. When reversing the first-channel audio signal and the second-channel audio signal, the processing section 114 transmits the channel-reversed audio signals to the display device 20 of the transmission destination via the communication section 302, and causes the display device 20 to reproduce reversed audios. In addition, when not reversing the first-channel audio signal and the second-channel audio signal, the processing section 114 transmits the audio signal corresponding to the image indicated by the image signal to the display device 20 of the transmission destination via the communication section 302, and causes the display device 20 to reproduce audios indicated by the audio signals.

In addition, the control section 306 has the same configuration as the imaging device 10 according to the first embodiment, thereby controlling communication with an external device in the communication section 302, for example, for path control, QoS-related control, control of transmission timing of an image signal with the display device 20 of a transmission object of the image signal, and the like.

The control section 306 includes the position specification section 110, the process determination section 112, and the processing section 114, for example, having the same functions as those of the control section 104 of the display control device 100 according to the first embodiment illustrated in FIG. 11, thereby initiatively performing a process related to a display control method according to this embodiment described above. Of course, a configuration for implementing the process related to the display control method according to this embodiment in the imaging device 300 is not limited to the configuration of the control section 306 illustrated in FIG. 16.

The imaging section 308 captures an image. Here, an imaging device including a lens-imaging element and a signal processing circuit is included as an example of the imaging section (not illustrated).

For example, like the display control device 100 according to the first embodiment illustrated in FIG. 11, the imaging device 300 can perform the process related to the display control method according to this embodiment, for example, according to a configuration illustrated in FIG. 16. Therefore, the imaging device 300 can reduce the sense of disharmony the user may feel, for example, according to the configuration illustrated in FIG. 16.

The configuration of the imaging device 300 according to the third embodiment is not limited to the configuration illustrated in FIG. 16. For example, the imaging device 300 may process an image captured by an external imaging device such as a connected external imaging device.

The display control system 3000 according to the third embodiment has the imaging device 300, which functions as the display control device according to this embodiment, for example, as illustrated in FIG. 15, and the display device 20. Here, the imaging device 300 performs the process related to the display control method according to this embodiment, for example, as illustrated in FIG. 6 or FIGS. 6 and 10, thereby causing the horizontal axis in the object the user directly views to be consistent with the horizontal axis in the object the user indirectly views via the image reflected on the display screen of the display device.

Therefore, the imaging device 300 is provided, thereby reducing the sense of disharmony the user may feel in the display control system 3000 according to the third embodiment.

In addition, although the imaging device 300 has been described above as a component constituting the display control system 3000 according to the third embodiment, this embodiment is not limited to this type. This embodiment can be applied to various devices having an imaging function, for example, including a video camera, a digital still camera, a computer such as a PC or a server, a portable communication device such as a portable phone or a PHS, a video/music reproduction device, a video/music recording/reproduction device, and a game machine.

As described above, one device constituting the display control system functions as the display control device according to this embodiment in the display control system according to this embodiment. Here, the display control device according to this embodiment can cause the horizontal axis in the object the user directly views to be consistent with the horizontal axis in the object the user indirectly views via the image reflected on the display screen of the display device, for example, by performing the above-described process (A) (the process of specifying positions of the imaging device and the display device) to the above-described process (C) (the process of selectively reversing the image in the horizontal direction and causing the display device to display the selectively reversed image).

Therefore, the display control device according to this embodiment is provided, thereby reducing the sense of disharmony the user may feel in the display control system according to this embodiment.

Here, in the display control system according to this embodiment, for example, as illustrated in FIG. 5, a display control device separated from the imaging device and the display device can be configured to intensively control a display in the display control system, and the imaging device or the display device can be configured to control the display in the display control system, for example, as illustrated in FIGS. 13 and 15. That is, the display control system according to this embodiment can cause a specific device to intensively perform a process related to the display control method according to this embodiment, or distribute the process related to the display control method according to this embodiment in a plurality of devices.

(Program According to This Embodiment)

It is possible to reduce the sense of disharmony the user may feel according to a program for causing a computer to function as the display control device according to this embodiment (for example, a program capable of executing a process related to the display control method according to this embodiment such as the above-described process (A) (the process of specifying positions of the imaging device and the display device) to the above-described process (C) (the process of selectively reversing the image in the horizontal direction and causing the display device to display the selectively reversed image)). In addition, the display control system capable of reducing the sense of disharmony the user may feel is implemented by executing a program for causing one device constituting the display control system to function as the display control device according to the embodiment described above.

It should be understood by those skilled in the art that various modifications, combinations, sub-combinations and alterations may occur depending on design requirements and other factors insofar as they are within the scope of the appended claims or the equivalents thereof.

For example, the display control device according to this embodiment may individually include the position specification section 110, the process specification section 112, and the processing section 114 illustrated in FIGS. 11, 14, and 16 (for example, each implemented by individual processing circuits).

In addition, although an example in which the program (computer program) for causing the computer to function as the display control device according to this embodiment is provided has been described above, it is possible to further provide a recording medium on which the above-described program has been recorded.

The aforementioned configuration is an example of this embodiment. It is obvious that such a configuration is within the technical scope of the present disclosure.

Additionally, the present technology may also be configured as below.

(1)

A display control device including:

a communication section for communicating with an external device;

a position specification section for specifying positions of an imaging device, which captures an image, and a display device, which displays the image;

a process determination section for determining whether to reverse the image captured by the imaging device in a horizontal direction on the basis of the position of the display device, which displays the image, and the position of the imaging device, which captures the image to be displayed; and

a processing section for selectively reversing the image captured by the imaging device in the horizontal direction,

wherein the processing section

causes the display device to display the image reversed in the horizontal direction, by reversing the image captured by the imaging device in the horizontal direction, if the image is determined to be reversed in the horizontal direction, and

causes the display device to display the image captured by the imaging device, if the image is determined not to be reversed in the horizontal direction.

(2)

The display control device according to (1), wherein when there are audio signals of a plurality of channels indicating audios corresponding to the captured image,

the processing section causes the display device to reproduce audios indicated by the reversed audio signals by reversing a first-channel audio signal and a second-channel audio signal among the audio signals, if the image is determined to be reversed in the horizontal direction.

(3)

The display control device according to (1) or (2), further including:

a position detection section for detecting a position of its own device.

(4)

The display control device according to any one of (1) to (3), further including:

an imaging section for capturing the image,

wherein, if its own device is the imaging device, which captures the image to be displayed on the display device,

the process determination section determines whether to cause the image captured by the imaging section to be reversed in the horizontal direction on the basis of the position of its own device and the position of the display device, which displays the image, and

the processing section causes an image signal indicating the image reversed in the horizontal direction to be transmitted to the display device, if the image is determined to be reversed in the horizontal direction, and causes the image signal indicating the image captured by the imaging section to be transmitted to the display device, if the image is determined not to be reversed in the horizontal direction.

(5)

The display control device according to any one of (1) to (3), further including:

a display section for displaying the image,

wherein, if its own device is the display device, which displays the image captured by the imaging device,

the process determination section determines whether to cause the image captured by the imaging device to be reversed in the horizontal direction on the basis of the position of its own device and the position of the imaging device, and

the processing section

causes the display section to display the image reversed in the horizontal direction, by reversing the image indicated by the image signal transmitted from the imaging device and received by the communication section in the horizontal direction, if the image is determined to be reversed in the horizontal direction, and

causes the display section to display the image indicated by the image signal transmitted from the imaging device and received by the communication section, if the image is determined not to be reversed in the horizontal direction.

(6)

The display control device according to any one of (1) to (3), wherein

the communication section communicates with one or more imaging devices and one or more display devices, and

the processing section

causes the image signal indicating the image reversed in the horizontal direction to be transmitted to a display device of a transmission destination of the image signal transmitted from the imaging device, by reversing the image indicated by the image signal transmitted from the imaging device and received by the communication section in the horizontal direction, if the image is determined to be reversed in the horizontal direction, and

causes the image signal transmitted from the imaging device and received by the communication section to be transmitted to the display device of the transmission destination, if the image is determined not to be reversed in the horizontal direction.

(7)

A display control method including:

specifying positions of an imaging device, which captures an image, and a display device, which displays the image;

determining whether to cause the image captured by the imaging device to be reversed in a horizontal direction on the basis of the position of the display device, which displays the image, and the position of the imaging device, which captures the image to be displayed; and

selectively reversing the image captured by the imaging device in the horizontal direction,

wherein the reversing step includes

causing the display device to display the image reversed in the horizontal direction, by reversing the image captured by the imaging device in the horizontal direction, if the image is determined to be reversed in the horizontal direction, and

causing the display device to display the image captured by the imaging device, if the image is determined not to be reversed in the horizontal direction.

(8)

A program for causing a computer to execute:

specifying positions of an imaging device, which captures an image, and a display device, which displays the image;

determining whether to cause the image captured by the imaging device to be reversed in a horizontal direction on the basis of the position of the display device, which displays the image, and the position of the imaging device, which captures the image to be displayed; and

selectively reversing the image captured by the imaging device in the horizontal direction,

wherein the reversing step includes

causing the display device to display the image reversed in the horizontal direction, by reversing the image captured by the imaging device in the horizontal direction, if the image is determined to be reversed in the horizontal direction, and

causing the display device to display the image captured by the imaging device, if the image is determined not to be reversed in the horizontal direction.

(9)

A display control system including:

an imaging device for capturing one or more images;

a display device for displaying the one or more images;

a display control device for communicating with the imaging device and the display device,

wherein the display control device includes

a communication section for communicating with the imaging device and the display device,

a position specification section for specifying positions of the imaging device and the display device,

a process determination section for determining whether to cause the image captured by the imaging device to be reversed in a horizontal direction on the basis of the position of the display device, which displays the image, and the position of the imaging device, which captures the image to be displayed, and

a processing section for selectively reversing the image captured by the imaging device in the horizontal direction,

wherein the processing section

causes the image signal indicating the image reversed in the horizontal direction to be transmitted to a display device of a transmission destination of the image signal transmitted from the imaging device, by reversing the image indicated by the image signal transmitted from the imaging device and received by the communication section in the horizontal direction, if the image is determined to be reversed in the horizontal direction, and

causes the image signal transmitted from the imaging device and received by the communication section to be transmitted to the display device of the transmission destination, if the image is determined not to be reversed in the horizontal direction.

The present disclosure contains subject matter related to that disclosed in Japanese Priority Patent Application JP 2011-085177 filed in the Japan Patent Office on Apr. 7, 2011, the entire content of which is hereby incorporated by reference.

What is claimed is:

1. A display control device comprising:
a communication section for communicating with an external device;
a position specification section for specifying positions of an imaging device, which captures an image, and a display device, which displays the image;
a process determination section for determining whether to reverse the image captured by the imaging device in a horizontal direction on the basis of the position of the display device, which displays the image, and the position of the imaging device, which captures the image to be displayed; and
a processing section for selectively reversing the image captured by the imaging device in the horizontal direction,
wherein the processing section
causes the display device to display the image reversed in the horizontal direction, by reversing the image captured by the imaging device in the horizontal direction, if the image is determined to be reversed in the horizontal direction, and
causes the display device to display the image captured by the imaging device, if the image is determined not to be reversed in the horizontal direction.

2. The display control device according to claim 1, wherein when there are audio signals of a plurality of channels indicating audios corresponding to the captured image,
the processing section causes the display device to reproduce audios indicated by the reversed audio signals by reversing a first-channel audio signal and a second-channel audio signal among the audio signals, if the image is determined to be reversed in the horizontal direction.

3. The display control device according to claim 1, further comprising:
a position detection section for detecting a position of its own device.

4. The display control device according to claim 1, further comprising:
an imaging section for capturing the image,
wherein, if its own device is the imaging device, which captures the image to be displayed on the display device,
the process determination section determines whether to cause the image captured by the imaging section to be reversed in the horizontal direction on the basis of the position of its own device and the position of the display device, which displays the image, and
the processing section causes an image signal indicating the image reversed in the horizontal direction to be transmitted to the display device, if the image is determined to be reversed in the horizontal direction, and causes the image signal indicating the image captured by the imaging section to be transmitted to the display device, if the image is determined not to be reversed in the horizontal direction.

5. The display control device according to claim 1, further comprising:
a display section for displaying the image,
wherein, if its own device is the display device, which displays the image captured by the imaging device,
the process determination section determines whether to cause the image captured by the imaging device to be reversed in the horizontal direction on the basis of the position of its own device and the position of the imaging device, and
the processing section
causes the display section to display the image reversed in the horizontal direction, by reversing the image indicated by the image signal transmitted from the imaging device and received by the communication section in the horizontal direction, if the image is determined to be reversed in the horizontal direction, and
causes the display section to display the image indicated by the image signal transmitted from the imaging device and received by the communication section, if the image is determined not to be reversed in the horizontal direction.

6. The display control device according to claim 1, wherein
the communication section communicates with one or more imaging devices and one or more display devices, and
the processing section
causes the image signal indicating the image reversed in the horizontal direction to be transmitted to a display device of a transmission destination of the image signal transmitted from the imaging device, by reversing the image indicated by the image signal transmitted from the imaging device and received by the communication section in the horizontal direction, if the image is determined to be reversed in the horizontal direction, and
causes the image signal transmitted from the imaging device and received by the communication section to be transmitted to the display device of the transmission destination, if the image is determined not to be reversed in the horizontal direction.

7. A display control method comprising:
specifying positions of an imaging device, which captures an image, and a display device, which displays the image;
determining whether to cause the image captured by the imaging device to be reversed in a horizontal direction on the basis of the position of the display device, which displays the image, and the position of the imaging device, which captures the image to be displayed; and
selectively reversing the image captured by the imaging device in the horizontal direction,
wherein the reversing step includes
causing the display device to display the image reversed in the horizontal direction, by reversing the image captured by the imaging device in the horizontal direction, if the image is determined to be reversed in the horizontal direction, and
causing the display device to display the image captured by the imaging device, if the image is determined not to be reversed in the horizontal direction.

8. A program for causing a computer to execute:
specifying positions of an imaging device, which captures an image, and a display device, which displays the image;
determining whether to cause the image captured by the imaging device to be reversed in a horizontal direction on the basis of the position of the display device, which displays the image, and the position of the imaging device, which captures the image to be displayed; and
selectively reversing the image captured by the imaging device in the horizontal direction,
wherein the reversing step includes
causing the display device to display the image reversed in the horizontal direction, by reversing the image captured by the imaging device in the horizontal direction, if the image is determined to be reversed in the horizontal direction, and
causing the display device to display the image captured by the imaging device, if the image is determined not to be reversed in the horizontal direction.

9. A display control system comprising:
an imaging device for capturing one or more images;
a display device for displaying the one or more images;
a display control device for communicating with the imaging device and the display device,
wherein the display control device includes
a communication section for communicating with the imaging device and the display device,
a position specification section for specifying positions of the imaging device and the display device,
a process determination section for determining whether to cause the image captured by the imaging device to be reversed in a horizontal direction on the basis of the position of the display device, which displays the image, and the position of the imaging device, which captures the image to be displayed, and
a processing section for selectively reversing the image captured by the imaging device in the horizontal direction,
wherein the processing section
causes the image signal indicating the image reversed in the horizontal direction to be transmitted to a display device of a transmission destination of the image signal transmitted from the imaging device, by reversing the image indicated by the image signal transmitted from the imaging device and received by the communication section in the horizontal direction, if the image is determined to be reversed in the horizontal direction, and
causes the image signal transmitted from the imaging device and received by the communication section to be transmitted to the display device of the transmission destination, if the image is determined not to be reversed in the horizontal direction.
